(19) United States
(12) Patent Application Publication
(10) Pub. No.: US 2026/0359397 A1
(43) Pub. Date: Nov. 12, 2026

(54) Multi-Signal Fusion Architecture for Semantic Leak Detection in Large Language Model Inputs

(71) Applicant: Zscaler, Inc., San Jose, CA (US)

(72) Inventors: Kaustav Saha, Fremont, CA (US); Shwetank Raghuvanshi, San Ramon, CA (US); Batool Haider, Lawrence, KS (US); Kliton Andrea, Hanover, MA (US); Chenhui Hu, Lexington, MA (US); Subramanian Srinivasan, Milpitas, CA (US); Ashwin Kesireddy, San Jose, CA (US)

(73) Assignee: Zscaler, Inc., San Jose, CA (US)

(21) Appl. No.: 19/685,482

(22) Filed: May 22, 2026

Related U.S. Application Data
(60) Provisional application No. 63/990,625, filed on Feb. 25, 2026.

(51) Int. Cl. G06F 18/22; G06F 18/25; G06F 40/295

(52) U.S. Cl. CPC G06F 18/22; G06F 18/25; G06F 40/295

(57) ABSTRACT

A system detects semantic leakage of contextual information in a prompt to a large language model (LLM) by extracting, in parallel from a reference context and a user input, a cosine similarity signal from multilingual sentence embeddings, an entity overlap signal from extracted named entities, and a number match signal from extracted numerical patterns. Fusion weights are selected from a plurality of language-tier weight profiles based on a detected language of the user input, and a fused score is computed as a weighted combination of the signals. The reference context and the user input are routed onto a fast trigger path, a fast safe path, or a gray zone path. A cross-encoder is selectively invoked to produce a cross-encoder score only when the gray zone path is selected. A verdict is produced indicating whether the user input semantically reproduces content from the reference context.

### CROSS-REFERENCE TO RELATED APPLICATION(S)

The present application claims the benefit of priority to U.S. Provisional Patent Application No. 63/990,625, filed Feb. 25, 2026, and entitled “Multi-Signal Fusion Architecture for Semantic Leak Detection with Adaptive Bi-Encoder Embeddings, Named Entity Overlap, Locale-Aware Pattern Matching, and Cross-Encoder Reranking with Tier-Based Multilingual Optimization” the entire contents of which are hereby incorporated by reference.

### FIELD OF THE DISCLOSURE

The present disclosure relates generally to networking and computer security. More particularly, the present disclosure relates to systems and methods for detecting semantic leakage of contextual information in user prompts submitted to large language models using multi-signal convergent evidence.

### BACKGROUND OF THE DISCLOSURE

Enterprises increasingly integrate large language models (LLMs) into internal workflows, customer-facing applications, and developer tooling. In a common deployment pattern, an enterprise application supplies one or more reference documents as background context to the LLM together with a user's prompt. The reference context may include financial reports, legal agreements, research, source code, strategic plans, customer records, or other information the enterprise treats as confidential. The LLM then generates a response that draws on both the reference context and the user's prompt.

This deployment pattern creates a class of data exfiltration risk that is not adequately addressed by conventional data loss prevention (DLP) systems. A user can extract, paraphrase, summarize, translate, or otherwise reformulate the reference context through the prompt itself, causing the confidential content to leave the enterprise boundary in a form that does not match the original wording. The Open Worldwide Application Security Project (OWASP) has identified sensitive information disclosure as a top-tier vulnerability for LLM applications.

Conventional DLP systems detect data exfiltration using exact-match keyword lists, regular expression patterns, and document fingerprinting techniques such as MinHash or SimHash. These approaches are effective against verbatim reproduction of structured identifiers but fail against semantic reformulations. For example, a user who paraphrases a recital that “Q3 revenue was $14.2 M, up 23% YoY” as “third quarter income reached fourteen million dollars with a year-over-year increase exceeding twenty percent” evades regex-based (regular expression) detection while disclosing the same underlying facts. Industry reports describe false positive rates for deployed DLP systems in the range of one to five percent, and a substantial fraction of DLP deployments are partially disabled within twelve months of installation due to alert fatigue.

Single-model approaches based on sentence-embedding bi-encoders, cross-encoders, or natural language inference (NLI) classifiers partially address paraphrase detection but have their own limitations. A single embedding score collapses several independent dimensions of similarity, such as topical overlap, named entity reuse, numerical reproduction, and structural copying, into one scalar that cannot be decomposed to distinguish a legitimate topically related query from an actual leak. Cross-encoders trained on general passage ranking corpora tend to under-score colloquially paraphrased content containing slang, abbreviations, or informal reformulations, producing false negatives on material a human reviewer would identify as a leak. Multilingual coverage is typically obtained through language-specific models or per-language adapters, which add infrastructure complexity, increase latency, and exhibit degraded accuracy on morphologically complex and lower-resource languages.

Threshold tuning, ensembling, and expanded keyword lists do not resolve these limitations. Raising the trigger threshold to reduce false positives discards true positives at a roughly linear rate, while lowering the threshold to improve recall accelerates false positive growth. Ensembling multiple models compounds latency and infrastructure cost. Expanded keyword lists fail on non-Latin scripts and on paraphrased content generally. As a result, there is a need for systems and methods that detect semantic leakage of reference context information in LLM prompts with high precision, high recall, low latency, and uniform coverage across many natural languages.

### BRIEF SUMMARY OF THE DISCLOSURE

The present disclosure provides systems and methods for detecting semantic leakage of contextual information in a prompt to a large language model (LLM). A detector extracts, in parallel from a reference context and a user input, a plurality of signals including a cosine similarity signal computed on multilingual sentence embeddings, an entity overlap signal computed using a tiered set of named entity recognition (NER) models with a dual-ratio scoring formulation, and a number match signal computed using locale-aware regular expressions with the dual-ratio scoring formulation. The detector selects fusion weights from one of a plurality of language-tier weight profiles based on a detected language of the user input and computes a fused score as a weighted combination of the signals. A confidence router directs the reference context and the user input onto a fast trigger path, a fast safe path, or a gray zone path based on the fused score and one or more tier-specific thresholds. A cross-encoder is selectively invoked only when the gray zone path is selected. A two-mode no-data guard enforces precision-support requirements on trigger decisions, reusing precision-support evidence from a code similarity signal and a text token overlap signal. The detector produces a verdict indicating whether the user input semantically reproduces content from the reference context.

### BRIEF DESCRIPTION OF THE DRAWINGS

The present disclosure is illustrated and described with reference to the accompanying drawings, in which like reference numerals denote like elements throughout. The drawings are provided to facilitate understanding of exemplary embodiments and are not intended to limit the scope of the claims. Unless otherwise indicated, the drawings are not necessarily drawn to scale, and certain features may be enlarged, simplified, or schematically represented for clarity.

FIG. 1 is a diagram of a multi-signal semantic leak detection system according to an embodiment of the present disclosure.

FIG. 2 is a diagram of a bi-encoder signal extraction subsystem of the system of FIG. 1 according to an embodiment of the present disclosure.

FIG. 3 is a diagram of a dual-ratio scoring subsystem of the system of FIG. 1 according to an embodiment of the present disclosure.

FIG. 4 is a bar chart illustrating a tier-based adaptive weight redistribution scheme implemented by a weighted fusion module of the system of FIG. 1 according to an embodiment of the present disclosure.

FIG. 5 is a diagram of a confidence routing subsystem of the system of FIG. 1 according to an embodiment of the present disclosure.

FIG. 6 is a diagram of a no-data guard subsystem of the system of FIG. 1 according to an embodiment of the present disclosure.

FIG. 7 is a diagram of a multi-context aggregation subsystem of the system of FIG. 1 according to an embodiment of the present disclosure.

FIG. 8 is a graph illustrating batch inference scaling characteristics of the system of FIG. 1 according to an embodiment of the present disclosure.

FIG. 9 is a bar chart illustrating aggregate performance characteristics of the system of FIG. 1 across a multilingual evaluation corpus according to an embodiment of the present disclosure.

FIG. 10 is a table illustrating aggregate performance metrics of the system of FIG. 1 across the multilingual evaluation corpus of FIG. 9 according to an embodiment of the present disclosure.

FIG. 11 is a graph illustrating a receiver operating characteristic curve of the system of FIG. 1 across the multilingual evaluation corpus of FIG. 9 according to an embodiment of the present disclosure.

FIG. 12 is a bar chart illustrating an ablation analysis of the system of FIG. 1 across a plurality of signal configurations according to an embodiment of the present disclosure.

FIG. 13 is a bar chart illustrating a cumulative false negative reduction analysis of the system of FIG. 1 across a plurality of architectural innovations according to an embodiment of the present disclosure.

FIG. 14 is a diagram illustrating a decision path distribution of the system of FIG. 1 across the multilingual evaluation corpus of FIG. 9 according to an embodiment of the present disclosure.

FIG. 15 is a block diagram of an example computing system that may be used to implement one or more components of the system of FIG. 1 according to an embodiment of the present disclosure.

### DETAILED DESCRIPTION OF THE DISCLOSURE

The present disclosure relates to systems and methods for detecting semantic leakage of contextual information in user prompts submitted to large language models (LLMs). In an enterprise deployment of an LLM-powered application, the application typically supplies a reference context to the LLM along with a user's prompt. The reference context may include a portion of a sensitive document, a system instruction set, a knowledge base passage retrieved by a retrieval augmented generation (RAG) pipeline, source code, customer records, or other information the enterprise treats as confidential. A semantic leak occurs when the user's prompt reproduces, paraphrases, summarizes, translates, or otherwise reformulates content from the reference context in a manner that causes the confidential content, or facts derived from the confidential content, to leave the enterprise boundary through the prompt itself. Unlike a verbatim copy-paste, a semantic leak does not produce regular-expression or keyword matches against the original wording and is therefore difficult to detect using conventional data loss prevention (DLP) techniques.

In various embodiments, a detector receives a detection request that identifies a reference context and a user input and produces a verdict indicating whether the user input semantically reproduces content from the reference context. The detector performs parallel extraction of a plurality of complementary signals from the reference context and the user input. A first signal is a bi-encoder cosine similarity computed on multilingual sentence embeddings. A second signal is a named entity overlap computed using a tiered set of named entity recognition (NER) models with a dual-ratio scoring formulation. A third signal is a number and pattern match computed using locale-aware regular expressions supporting a plurality of international number formats, also using the dual-ratio scoring formulation. Additional precision-support signals include a code similarity signal computed on whitespace-normalized code tokens with a multi-indicator code gate, and a text token overlap signal computed as a product of coverage and specificity on content-bearing tokens. The detector combines a subset of the signals using a weighted fusion formula whose coefficients are selected from one of a plurality of language-tier profiles based on a detected language of the user input. A confidence router directs the request onto one of a plurality of decision paths based on the fused score and a plurality of bypass conditions. A cross-encoder reranker is selectively invoked only for requests that fall into a gray zone, and a no-data guard module operating in two modes enforces precision-support requirements before a trigger decision is finalized.

The systems and methods of the present disclosure address several limitations of conventional approaches to semantic leak detection. Conventional DLP systems based on exact-match keywords, regular expressions, or document fingerprinting cannot detect paraphrased or summarized reproductions of sensitive content. Single-model approaches based on a sentence-embedding bi-encoder, a cross-encoder, or a natural language inference classifier collapse multiple independent dimensions of similarity into a single scalar, making it difficult to distinguish a legitimate topically related query from an actual leak. Cross-encoders trained on general passage-ranking corpora tend to under-score colloquially paraphrased content. Multilingual coverage obtained through per-language models or adapters adds infrastructure complexity and exhibits degraded accuracy on morphologically complex and lower-resource languages. The systems and methods described herein decompose the detection problem into a plurality of orthogonal signals, each of which targets a distinct dimension of similarity, and combine the signals through tier-adaptive weighting, bypass conditions, and confidence-based routing so that the strengths of each signal compensate for the weaknesses of the others.

Representative use cases for the systems and methods described herein include enterprise gateway inspection of prompts sent to a hosted LLM service, inline inspection of prompts entered into an LLM-powered productivity application, content moderation of prompts submitted to a RAG-based assistant grounded on internal documents, inspection of prompts submitted to a developer-assistant LLM that has been provided with proprietary source code as reference context, and policy enforcement at a cloud access security broker (CASB) or secure web gateway (SWG) that proxies LLM traffic for a managed enterprise. The systems and methods are not limited to these use cases and are applicable to any deployment in which a user submits a prompt that is evaluated together with, or in proximity to, a trusted reference document.

The systems and methods of the present disclosure provide a number of technical advantages. A first advantage is improved detection of paraphrased, summarized, translated, and multi-fact synthesis leaks that are missed by exact-match DLP and by single-model approaches. A second advantage is reduced false positives on topically related but non-leaking queries, achieved through corroboration guards and a two-mode no-data guard that requires precision-support evidence before a trigger decision is finalized. A third advantage is uniform coverage across a plurality of natural languages, achieved through a tier-based adaptive weighting scheme that adjusts signal weights and routing thresholds based on the quality of available NER and cross-encoder models for the detected language, without requiring per-language retraining of any model. A fourth advantage is low end-to-end latency, achieved through parallel signal extraction and confidence-based routing that causes the computationally expensive cross-encoder to be invoked only for requests in the gray zone. A fifth advantage is high throughput under batched inference, achieved through a batched pipeline in which the bi-encoder, NER models, regular-expression extractors, and cross-encoder each operate on grouped inputs in a single forward pass or pipe invocation. A sixth advantage is native support for multi-context detection, in which an arbitrary number of reference documents are evaluated in parallel against a single user input with per-context thresholds, with verdicts aggregated under OR-trigger semantics so that a trigger against any one reference document produces a leak verdict.

The systems and methods described herein are described in the context of an enterprise LLM gateway and an artificial intelligence security platform. However, the underlying architecture, including the parallel signal extraction pipeline, the dual-ratio scoring formulation, the tier-adaptive weighted fusion module, the bypass conditions, the two-mode no-data guard, and the confidence-based routing mechanism, is applicable more broadly to any multilingual text-matching task in which a candidate text is compared against a trusted reference text and high precision, high recall, and low latency are required. Additional applications include plagiarism detection, contract clause comparison, prior-art search, regulatory compliance monitoring of financial disclosures, and detection of leakage of proprietary source code into outbound text channels.

### § 1.0 System Architecture

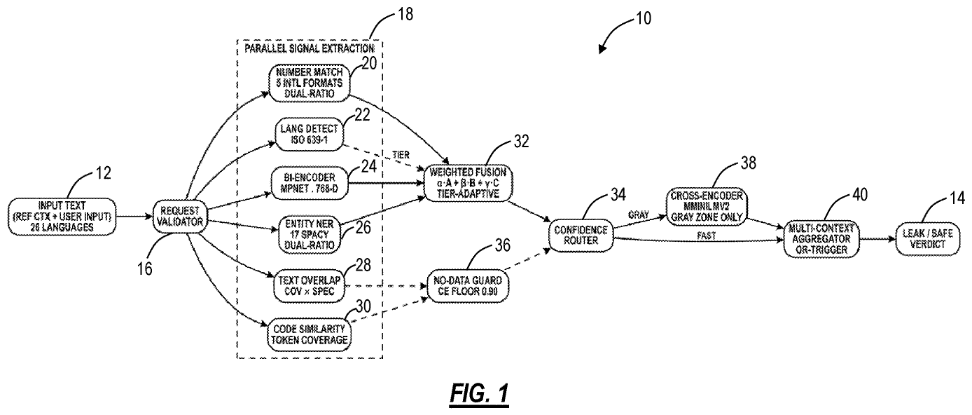

FIG. 1 is a diagram of a multi-signal semantic leak detection system 10 according to an embodiment of the present disclosure. The system 10 receives input text 12 that includes a reference context and a user input and produces a leak or safe verdict 14 indicating whether the user input semantically reproduces content from the reference context. The system 10 supports input text 12 in a plurality of natural languages, such as twenty-six natural languages in one embodiment.

The input text 12 may be obtained from any of a variety of sources at which a user-supplied prompt is presented to, or in proximity to, a trusted reference document. In one embodiment, the user input portion of the input text 12 is a prompt that a user has submitted to an LLM-powered application, and the reference context portion of the input text 12 is one or more documents, document excerpts, system instructions, or knowledge base passages that the LLM-powered application has supplied to the LLM as background context for the prompt. In another embodiment, the reference context portion of the input text 12 is a passage retrieved from an enterprise knowledge base by a retrieval augmented generation (RAG) pipeline in response to the user input, and the input text 12 is assembled by the LLM-powered application or by an inline inspection point before the prompt is dispatched to the LLM. In a further embodiment, the reference context portion of the input text 12 is source code, configuration data, or other technical artifacts supplied to a developer-assistant LLM as background context, and the user input portion is a developer's prompt directed at that LLM.

The system 10 may be integrated with one or more cybersecurity monitoring systems and enforcement points in an enterprise network. In one embodiment, the system 10 is integrated with a secure web gateway (SWG) that proxies outbound web traffic from a managed endpoint, such that the SWG identifies traffic destined for an LLM service, extracts the reference context and the user input from a request body, and submits the extracted content to the system 10 as the input text 12 before the request is forwarded to the LLM service. In another embodiment, the system 10 is integrated with a cloud access security broker (CASB) that brokers application programming interface (API) calls to a software-as-a-service (SaaS) LLM application, such that the CASB intercepts API requests that include a reference context and a user input and submits the intercepted content to the system 10 for evaluation against an enterprise data loss prevention (DLP) policy. In a further embodiment, the system 10 is integrated with a zero trust network access (ZTNA) service or a security service edge (SSE) platform that enforces per-user access policies on traffic to LLM endpoints, with the leak or safe verdict 14 contributing to a policy decision regarding whether the prompt is allowed to reach the LLM, allowed in redacted form, blocked, or routed to a security analyst for review.

The system 10 may also be integrated with cybersecurity monitoring systems that operate on a record of LLM traffic rather than inline with the traffic itself. In one embodiment, the leak or safe verdict 14, together with associated signal scores and a decision path label, is emitted as a structured event to a security information and event management (SIEM) system, an extended detection and response (XDR) platform, or a security orchestration, automation, and response (SOAR) platform. The structured event may include the reference context identifier, a hash of the user input, the per-signal scores, the fused score, the decision path label, the matched reference context index in the case of multi-context evaluation, and a timestamp. The structured event enables downstream correlation with other security telemetry, such as endpoint detection and response (EDR) alerts, identity provider events, and data classification labels.

The system 10 may further be integrated as an inline content inspection component of a DLP system, an artificial intelligence (AI) security platform, or an LLM gateway. In one embodiment, the system 10 is deployed as one of a plurality of content inspection components in a DLP pipeline, such that the input text 12 is forwarded to the system 10 in parallel with, or in series with, exact-match keyword inspection, regular expression inspection, document fingerprint inspection, and structured-data classifiers, and the verdicts of the plurality of content inspection components are combined by a policy engine to produce a final allow, block, or redact action. In another embodiment, the system 10 is deployed as a content moderation component of an LLM gateway that fronts one or more hosted LLM services, such that every prompt routed through the LLM gateway is evaluated by the system 10 before the prompt is dispatched to a selected LLM. In a still further embodiment, the system 10 is deployed within an enterprise email security gateway or a collaboration-platform security service that inspects messages, attachments, and chat content for prompts that disclose contextual information drawn from a trusted reference source.

The system 10 is not limited to inline deployment. In one embodiment, the system 10 is invoked offline against a corpus of stored LLM transcripts to retroactively identify semantic leaks that occurred prior to deployment of inline inspection. In another embodiment, the system 10 is invoked as part of a red-team or compliance audit workflow against a synthetic prompt corpus to evaluate the leakage risk of a candidate LLM deployment. The input text 12 in such embodiments is obtained from a transcript store, a log archive, an audit dataset, or an evaluation harness, rather than from live user traffic.

A request validator 16 receives the input text 12 and validates the reference context and the user input before any machine learning inference is performed by the system 10. The request validator 16 serves several purposes. First, the request validator 16 protects the downstream signal extractors and the cross-encoder 38 from malformed, oversized, or otherwise abnormal inputs that could cause excessive resource consumption, latency spikes, or denial-of-service conditions on shared compute infrastructure. Second, the request validator 16 normalizes the reference context and the user input into a canonical textual form, so that downstream signal extractors operate on consistent inputs and so that benign variations in character encoding do not produce inconsistent verdicts. Third, the request validator 16 fails fast on invalid requests, returning a structured error response without invoking any of the bi-encoder 24, the entity NER extractor 26, the number match extractor 20, the text overlap extractor 28, the code similarity extractor 30, the language detector 22, the weighted fusion module 32, the confidence router 34, the no-data guard module 36, the cross-encoder 38, or the multi-context aggregator 40, thereby preserving compute resources on the system 10 for valid requests.

The request validator 16 applies a byte-level cap to the input text 12. The byte-level cap rejects an input text 12 whose serialized length, measured in bytes after transport-layer decoding, exceeds a configurable maximum, such as a maximum of approximately four kilobytes per input text field in one embodiment. The byte-level cap operates before any tokenization or model loading is performed, so that a maliciously large or malformed request is rejected at the earliest possible point in the pipeline. The byte-level cap also bounds the maximum payload size that any single replica of the system 10 must hold in memory at one time, which simplifies capacity planning for clustered deployments.

The request validator 16 also applies a token-level cap to the reference context and to the user input. The token-level cap is enforced using a token count estimator that approximates the number of subword tokens that would be produced by a downstream tokenizer, without actually loading the tokenizer model at validation time. In one embodiment, the token count estimator multiplies a whitespace-delimited word count by a fixed multiplier, such as a multiplier of approximately 1.3, for languages that use whitespace as a word separator, and counts characters directly for languages that do not use whitespace as a word separator, such as Chinese, Japanese, and Thai. The token-level cap rejects a reference context that exceeds a context token cap, such as a context token cap of approximately fifty thousand tokens in one embodiment, and rejects a user input that exceeds an input token cap, such as an input token cap of approximately two thousand tokens in one embodiment. The asymmetry between the two caps reflects the asymmetric roles of the reference context and the user input. The reference context is supplied by a trusted enterprise application and may be substantially larger, while the user input is typically a single prompt entered by a user.

The request validator 16 verifies that a detection threshold associated with the input text 12 lies in a permitted range. The detection threshold is a numeric parameter that controls the sensitivity of the confidence router 34, with lower values producing more trigger decisions and higher values producing fewer trigger decisions. In one embodiment, the permitted range for the detection threshold is the half-open interval from zero, exclusive, to one, inclusive. A detection threshold outside the permitted range, a detection threshold that is not a numeric value, or a missing detection threshold causes the request validator 16 to reject the input text 12.

When the input text 12 includes a list of reference contexts and a corresponding list of per-context detection thresholds, as in a multi-context evaluation, the request validator 16 applies the byte-level cap, the token-level cap, and the threshold range check to each reference context and each corresponding detection threshold individually. The request validator 16 further verifies that the list of reference contexts and the list of per-context detection thresholds are well-formed, such that each reference context has an associated detection threshold, and that the total number of reference contexts does not exceed a configurable maximum.

The request validator 16 applies a plurality of preprocessing operations to the reference context and the user input. In one embodiment, the preprocessing operations include Unicode normalization, whitespace collapse, and null-byte removal. Unicode normalization converts the reference context and the user input into a canonical normalization form, such as Normalization Form C (NFC), in which composed characters are preferred over their decomposed equivalents. Unicode normalization ensures that a character represented as a single composed code point in the reference context is treated as equivalent to the same character represented as a base code point followed by one or more combining code points in the user input, and vice versa, which improves the stability of downstream fuzzy substring matching and tokenization. Whitespace collapse replaces sequences of whitespace characters with a single space character and trims leading and trailing whitespace. Null-byte removal removes embedded null bytes from the reference context and the user input. Embedded null bytes have no legitimate role in a user prompt and may be used in an attempt to confuse downstream tokenizers or string-handling code.

The request validator 16 may apply one or more additional preprocessing operations. In one embodiment, the additional preprocessing operations include removal of zero-width characters, such as the zero-width space, the zero-width non-joiner, and the zero-width joiner, which are sometimes inserted into text to evade exact-match detection. In another embodiment, the additional preprocessing operations include normalization of homoglyph characters drawn from confusable scripts. In a further embodiment, the additional preprocessing operations include removal of control characters other than newline and tab.

When the input text 12 fails any validation check applied by the request validator 16, the request validator 16 produces a structured error response in lieu of the leak or safe verdict 14 and does not invoke any downstream module of the system 10. The structured error response identifies the validation check that failed using a machine-readable error code. In one embodiment, the structured error response uses error codes that distinguish, for example, an empty reference context, a reference context that exceeds the context token cap, an empty user input, a user input that exceeds the input token cap, and a detection threshold outside the permitted range. The structured error response enables an upstream integration point, such as an LLM gateway, an SWG, a CASB, or an LLM-powered application, to surface a meaningful diagnostic to the calling code or to a user, and enables a SIEM, an XDR platform, or a SOAR platform to correlate validation failures with other security telemetry.

When the input text 12 passes all validation checks applied by the request validator 16, the request validator 16 forwards the reference context and the user input, in their preprocessed canonical form, to the parallel signal extraction stage 18. The request validator 16 may further forward the detection threshold, the list of per-context detection thresholds in the case of multi-context evaluation, and any additional metadata, such as a tenant identifier, a tracing identifier, or a request identifier, to the parallel signal extraction stage 18 and to downstream modules.

The parallel signal extraction stage 18 includes a plurality of signal extractors that operate concurrently on the reference context and the user input. A number match extractor 20 extracts numerical and structured patterns, such as monetary amounts, percentages, dates, network port numbers, software version strings, and Internet Protocol (IP) addresses, from the reference context and the user input. The number match extractor 20 supports a plurality of international number formats, such as five international number formats in one embodiment, and applies a dual-ratio scoring formulation to produce a number match signal.

A language detector 22 examines the user input and produces a language code, such as a code conforming to the International Organization for Standardization (ISO) 639-1 standard. The language code identifies the language of the user input and is used downstream to select a named entity recognition (NER) model and to select a language-tier weight profile for signal fusion.

A bi-encoder 24 encodes the reference context and the user input into multilingual sentence embeddings. In one embodiment, the bi-encoder 24 is a multilingual paraphrase model that produces a 768-dimensional L2-normalized sentence embedding for each of the reference context and the user input. The bi-encoder 24 produces a cosine similarity signal as a dot product of the two L2-normalized embeddings.

An entity NER extractor 26 extracts named entities from the reference context and the user input using a tiered set of NER models. In one embodiment, the entity NER extractor 26 employs seventeen spaCy NER models, including sixteen language-specific models and one multilingual fallback model. The entity NER extractor 26 applies fuzzy substring matching between extracted entities and produces an entity overlap signal using the dual-ratio scoring formulation shared with the number match extractor 20.

A text overlap extractor 28 produces a text token overlap signal from content-bearing tokens of the reference context and the user input. The text overlap extractor 28 computes the text token overlap signal as a product of a coverage component and a specificity component, in which the coverage component measures the fraction of user input content tokens that appear in the reference context and the specificity component measures the fraction of reference context content tokens that appear in the user input.

A code similarity extractor 30 produces a code similarity signal when the user input contains source-code-like content. The code similarity extractor 30 applies a multi-indicator code gate that requires a configurable minimum number of independent code indicators, such as language keywords, multi-character operators, preprocessor directives, output calls, structured query language (SQL) keywords, function definition patterns, string literals, or assignment patterns, before the code similarity signal is computed. When the code gate is satisfied, the code similarity extractor 30 computes the code similarity signal as a token coverage score on whitespace-normalized code tokens.

A weighted fusion module 32 receives the cosine similarity signal from the bi-encoder 24, the entity overlap signal from the entity NER extractor 26, and the number match signal from the number match extractor 20, and combines the three signals into a fused score according to a weighted linear combination. Weights of the weighted linear combination are tier-adaptive and are selected from one of a plurality of language-tier weight profiles based on the language code produced by the language detector 22. In one embodiment, the weighted linear combination has the form α·A+β·B+γ·C, in which A is the cosine similarity signal, B is the entity overlap signal, C is the number match signal, and α, β, and γ are weights that sum to unity and that are selected based on the language tier.

A confidence router 34 receives the fused score from the weighted fusion module 32 and directs the input text 12 onto one of a plurality of decision paths based on the fused score and a plurality of bypass conditions. The confidence router 34 implements a fast path for inputs that are classified as safe or as a trigger with high confidence based on the fused score alone or based on one or more bypass conditions, and a gray-zone path for inputs in which the fused score falls between a low threshold and a high threshold.

A no-data guard module 36 enforces precision-support requirements on trigger decisions produced by the confidence router 34 and on trigger decisions produced by a downstream cross-encoder 38. The no-data guard module 36 receives the text token overlap signal from the text overlap extractor 28 and the code similarity signal from the code similarity extractor 30 as precision-support inputs. The no-data guard module 36 operates in two modes. In a first mode, the no-data guard module 36 reroutes a fast trigger candidate to the gray-zone path when the fused score falls below an upper bypass threshold and no precision-support evidence is present. In a second mode, the no-data guard module 36 applies a hard cross-encoder floor, such as a floor of 0.90, to trigger decisions produced by the cross-encoder 38 when no precision-support evidence is present.

The cross-encoder 38 is selectively invoked by the confidence router 34 only for input text 12 that falls into the gray zone. The cross-encoder 38 processes the reference context and the user input jointly through full transformer self-attention to produce a relevance score. In one embodiment, the cross-encoder 38 is a multilingual MiniLM-based cross-encoder trained on a multilingual passage-ranking corpus. The cross-encoder 38 produces a sigmoid-normalized relevance score that is compared against a tier-specific cross-encoder threshold, subject to the hard cross-encoder floor enforced by the no-data guard module 36 when no precision-support evidence is present.

A multi-context aggregator 40 receives per-context verdicts produced by the confidence router 34, the cross-encoder 38, and the no-data guard module 36, and aggregates the per-context verdicts into the leak or safe verdict 14. The multi-context aggregator 40 supports an arbitrary number of reference contexts evaluated in parallel against a single user input, with a per-context threshold associated with each reference context. The multi-context aggregator 40 applies OR-trigger semantics, in which a trigger against any one of the reference contexts produces the leak verdict 14, together with an identifier of which reference context produced the trigger.

The boxes shown in FIG. 1 may be implemented as computer-executed modules. Each of the request validator 16, the number match extractor 20, the language detector 22, the bi-encoder 24, the entity NER extractor 26, the text overlap extractor 28, the code similarity extractor 30, the weighted fusion module 32, the confidence router 34, the no-data guard module 36, the cross-encoder 38, and the multi-context aggregator 40 may be implemented as a software module, a hardware module, a firmware module, or any combination thereof, executing on one or more processors of one or more computing devices. The modules may be co-located on a single computing device, distributed across a plurality of computing devices in a clustered or containerized deployment, or instantiated as replicas of a model-serving framework, such as a Ray Serve deployment orchestrated by a Kubernetes cluster. The modules may communicate through in-process function calls, inter-process communication mechanisms, or network-based application programming interfaces (APIs). Computer-executable instructions implementing the modules may be stored on one or more non-transitory computer-readable media and executed by the one or more processors to cause the system 10 to perform the operations described herein.

### § 1.1 Bi-Encoder Similarity

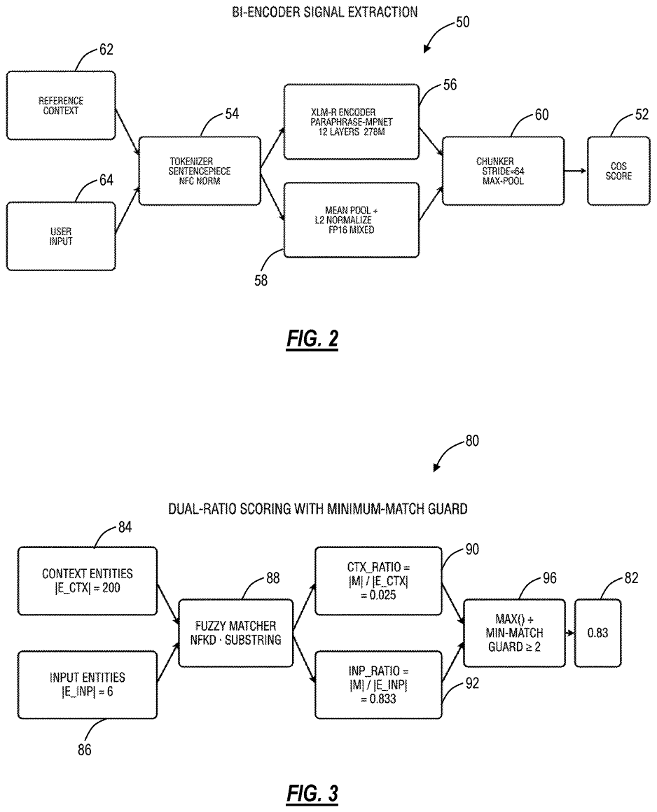

FIG. 2 is a diagram of a bi-encoder signal extraction subsystem 50 according to an embodiment of the present disclosure. The bi-encoder signal extraction subsystem 50 is an embodiment of the bi-encoder 24 of FIG. 1, and produces a cosine similarity score 52 representing a semantic similarity between a reference context 62 and a user input 64 of the input text 12. The bi-encoder signal extraction subsystem 50 includes a tokenizer 54, a transformer encoder 56, a pooling and normalization module 58, and a chunker 60.

The tokenizer 54 receives the reference context 62 and the user input 64 from the request validator 16 of FIG. 1 in preprocessed canonical form, and converts each of the reference context 62 and the user input 64 into a sequence of subword tokens drawn from a fixed subword vocabulary. In one embodiment, the tokenizer 54 implements a SentencePiece subword tokenization algorithm with a vocabulary of approximately two hundred fifty thousand subword units. The tokenizer 54 may further apply Unicode Normalization Form C (NFC) as a tokenizer-internal normalization step, in addition to the Unicode normalization already applied by the request validator 16, in order to handle any character substitutions that occur during tokenizer-internal preprocessing. The tokenizer 54 outputs a token identifier sequence and an attention mask for each of the reference context 62 and the user input 64.

The transformer encoder 56 receives the token identifier sequences and the attention masks produced by the tokenizer 54 and produces a sequence of contextual token embeddings for each of the reference context 62 and the user input 64. In one embodiment, the transformer encoder 56 is a multilingual sentence-transformer model based on a Cross-lingual Language Model RoBERTa (XLM-R) architecture, fine-tuned via contrastive learning on a large multilingual paraphrase corpus. In a particular embodiment, the transformer encoder 56 has approximately twelve transformer layers, approximately twelve attention heads per layer, a hidden dimension of approximately seven hundred sixty-eight, and approximately two hundred seventy-eight million parameters, and is configured to accept an input sequence of up to approximately one hundred twenty-eight subword tokens. The transformer encoder 56 may execute on a graphics processing unit (GPU), a tensor processing unit (TPU), a neural processing unit (NPU), or a general-purpose central processing unit (CPU), with automatic device selection and a fallback path from accelerator to CPU when no accelerator is available. The transformer encoder 56 may further operate under a reduced-precision arithmetic mode, such as a sixteen-bit floating-point (FP16) mixed-precision mode, an eight-bit integer (INT8) quantized mode, or a brain floating-point (BF16) mode, to reduce memory consumption and inference latency relative to a thirty-two-bit floating-point (FP32) mode.

The pooling and normalization module 58 receives the sequence of contextual token embeddings produced by the transformer encoder 56 for each of the reference context 62 and the user input 64, and produces a single fixed-dimensional sentence embedding for each of the reference context 62 and the user input 64. In one embodiment, the pooling and normalization module 58 applies mean pooling over the contextual token embeddings, weighted by the attention mask, such that padding tokens do not contribute to the pooled sentence embedding. The pooling and normalization module 58 then applies L2 normalization to the pooled sentence embedding, scaling the pooled sentence embedding to unit Euclidean norm. The L2 normalization is significant because, when both the embedding of the reference context 62 and the embedding of the user input 64 are L2-normalized, the cosine similarity between the two embeddings reduces to a dot product, as set forth in Equation (1):

Cos(u, v)=u_norm·v_norm (1)

in which u_norm is the L2-normalized sentence embedding of the reference context 62, v_norm is the L2-normalized sentence embedding of the user input 64, and the operator · denotes a vector dot product. Computing the cosine similarity as a dot product on L2-normalized vectors avoids a per-pair division by the product of the vector magnitudes, which reduces inference latency and simplifies batched implementation.

The chunker 60 handles a reference context 62 that, after tokenization by the tokenizer 54, produces a token sequence longer than a maximum sequence length supported by the transformer encoder 56. When the token sequence for the reference context 62 is no longer than the maximum sequence length, the chunker 60 passes the token sequence through to the transformer encoder 56 unchanged. When the token sequence for the reference context 62 exceeds the maximum sequence length, the chunker 60 divides the token sequence into a plurality of overlapping chunks, each chunk having a length no greater than the maximum sequence length. Adjacent chunks share a configurable number of overlapping tokens, such as approximately sixty-four overlapping tokens in one embodiment, so that semantic content that spans a chunk boundary is represented in at least one chunk in its entirety. The chunker 60 invokes the transformer encoder 56 and the pooling and normalization module 58 on each chunk to produce a chunk sentence embedding for each chunk. The chunker 60 then combines the plurality of chunk sentence embeddings into a single representative score by computing the cosine similarity between the sentence embedding of the user input 64 and each chunk sentence embedding, and applying element-wise max pooling across the plurality of resulting cosine similarities. The element-wise max pooling preserves the highest-similarity region of a long reference context 62, which corresponds to the most likely location of a semantic leak within the reference context 62, while discarding low-similarity regions that would otherwise dilute the cosine similarity score 52.

The bi-encoder signal extraction subsystem 50 produces the cosine similarity score 52 as a scalar value in a range from approximately zero to approximately one. A cosine similarity score 52 of approximately one indicates that the user input 64 is nearly identical in meaning to at least one chunk of the reference context 62, such as a verbatim quote, a close paraphrase, or a faithful summary. A cosine similarity score 52 of approximately zero indicates that the user input 64 is unrelated in meaning to any chunk of the reference context 62. A cosine similarity score 52 in an intermediate range indicates partial semantic overlap, such as a topical similarity without reproduction of specific facts. The cosine similarity score 52 is provided as the cosine similarity signal to the weighted fusion module 32 of FIG. 1 and is also evaluated against per-tier thresholds by the confidence router 34 of FIG. 1 in connection with one or more bypass conditions.

The bi-encoder signal extraction subsystem 50 may further include batching infrastructure that interleaves a plurality of reference contexts 62 and a corresponding plurality of user inputs 64 into a single forward pass of the transformer encoder 56. In one embodiment, the batching infrastructure assembles a batch of paired token sequences of the reference contexts 62 and the user inputs 64 in an interleaved arrangement, such as (reference_context_0, user_input_0, reference_context_1, user_input_1, . . . ,reference_context_N, user_input_N), and dispatches the assembled batch to the transformer encoder 56 in a single forward pass. The batched forward pass amortizes fixed per-invocation overhead, such as GPU kernel launch overhead, across a plurality of paired evaluations, and may achieve a per-pair inference latency on the order of a few milliseconds on a current-generation GPU. The batching infrastructure may select a batch size based on available accelerator memory, on a target end-to-end latency, or on a configurable batch size parameter. The batched forward pass is functionally equivalent to a sequence of single-pair forward passes and does not alter the cosine similarity score 52 produced for any individual pair.

The bi-encoder signal extraction subsystem 50 captures a broad class of semantic leak patterns. In particular, the cosine similarity score 52 is sensitive to verbatim and near-verbatim reproduction of content from the reference context 62, to close paraphrases that preserve meaning while substituting wording, to summarization of one or more passages of the reference context 62, to cross-lingual translations of content from the reference context 62, and to thematic similarity between the user input 64 and the reference context 62. The cosine similarity score 52, when considered in isolation, does not necessarily distinguish a genuine semantic leak from a topically related but non-leaking query. The system 10 addresses this limitation by combining the cosine similarity score 52 with the entity overlap signal produced by the entity NER extractor 26, the number match signal produced by the number match extractor 20, and, where appropriate, the cross-encoder score produced by the cross-encoder 38, and by applying the precision-support and corroboration constraints enforced by the confidence router 34 and the no-data guard module 36 of FIG. 1.

### § 1.2 Entity Overlap With Dual-Ratio Scoring

FIG. 3 is a diagram of a dual-ratio scoring subsystem 80 according to an embodiment of the present disclosure. The dual-ratio scoring subsystem 80 is employed by the entity NER extractor 26 of FIG. 1 to produce an entity overlap signal 82 representing an asymmetric overlap between a set of named entities extracted from the reference context 62 and a set of named entities extracted from the user input 64. The dual-ratio scoring subsystem 80 is also employed in a corresponding manner by the number match extractor 20 of FIG. 1 to produce a number match signal from sets of numerical patterns extracted from the reference context 62 and the user input 64, as described further in connection with a subsequent figure. The dual-ratio scoring subsystem 80 includes a context entity set 84, an input entity set 86, a fuzzy matcher 88, a context ratio calculator 90, an input ratio calculator 92, and a maximum selector with minimum-match guard 94.

The context entity set 84 is a set of named entities extracted from the reference context 62 by a tiered set of NER models. In one embodiment, the tiered set of NER models includes a plurality of language-specific NER models and a multilingual fallback NER model, such as seventeen spaCy NER models including sixteen language-specific models and one multilingual fallback model. The particular NER model used to extract the context entity set 84 is selected based on the language code produced by the language detector 22 of FIG. 1. The context entity set 84 has a cardinality denoted |E_ctx|. In an illustrative example shown in FIG. 3, the context entity set 84 has a cardinality of two hundred, indicating that the reference context 62 contains approximately two hundred named entities of the supported entity types.

The input entity set 86 is a set of named entities extracted from the user input 64 by the same NER model used to extract the context entity set 84, so that the two sets are drawn from a common label space and a common entity boundary convention. The input entity set 86 has a cardinality denoted |E_inp|. In the illustrative example of FIG. 3, the input entity set 86 has a cardinality of six, reflecting the typical asymmetry between a long reference context 62 and a short user input 64. The NER models extract named entities spanning a plurality of entity types. In one embodiment, the supported entity types include person, organization, geopolitical entity, location, product, event, work of art, law, facility, nationality or religious or political group, date, monetary amount, percentage, quantity, cardinal number, and miscellaneous. Loading only a tokenizer pipeline component and an NER pipeline component of each model, and disabling tagger, parser, attribute ruler, and lemmatizer pipeline components, reduces per-model memory consumption and per-invocation latency relative to a fully loaded pipeline.

The fuzzy matcher 88 receives the context entity set 84 and the input entity set 86 and produces a matched entity set having a cardinality denoted |M|. The fuzzy matcher 88 compares each entity of the input entity set 86 against each entity of the context entity set 84 under a fuzzy substring matching rule, rather than a strict equality rule, so that entity references that differ in capitalization, in honorifics, in titular qualifiers, or in inflectional or compositional form are correctly identified as matches. In one embodiment, the fuzzy matcher 88 applies case-insensitive normalization and Unicode Normalization Form KD (NFKD) decomposition to each entity prior to substring comparison. The NFKD decomposition decomposes composed characters into base characters followed by combining marks and decomposes compatibility characters into compatibility-equivalent base characters, so that characters that are visually identical but encoded differently are treated as equivalent. By way of illustration, an entity “Dr. Reed” appearing in the user input 64 matches an entity “Dr. Evelyn Reed” appearing in the reference context 62 under the fuzzy substring matching rule, because the surface form of the input entity is a substring of the context entity after normalization.

The context ratio calculator 90 computes a context ratio according to Equation (2):

ctx_ratio=|M|/|E_ctx| (2)

in which |M| is the cardinality of the matched entity set produced by the fuzzy matcher 88 and |E_ctx| is the cardinality of the context entity set 84. The context ratio represents the fraction of named entities of the reference context 62 that are also present in the user input 64. In the illustrative example of FIG. 3, with |M| equal to five and |E_ctx| equal to two hundred, the context ratio is approximately 0.025. The context ratio is sensitive to a leak in which a large portion of the named entities of the reference context 62 are reproduced in the user input 64, such as a verbatim or near-verbatim reproduction of a short reference context 62, and is comparatively insensitive to a concentrated leak in which a small number of named entities are extracted from a large reference context 62.

The input ratio calculator 92 computes an input ratio according to Equation (3):

inp_ratio=|M|/|E_inp| (3)

in which |E_inp| is the cardinality of the input entity set 86. The input ratio represents the fraction of named entities of the user input 64 that originate from the reference context 62. In the illustrative example of FIG. 3, with |M| equal to five and |E_inp| equal to six, the input ratio is approximately 0.833. The input ratio is sensitive to a concentrated leak in which a small number of named entities are extracted from a large reference context 62, because in such a leak a large fraction of the named entities of the user input 64 originate from the reference context 62, even though the same matched entities represent only a small fraction of the reference context 62.

The maximum selector with minimum-match guard 94 receives the context ratio from the context ratio calculator 90 and the input ratio from the input ratio calculator 92, and produces the entity overlap signal 82 according to Equation (4):

B=max(ctx_ratio, inp_ratio) (4)

subject to a minimum-match guard. The minimum-match guard suppresses the input ratio when the matched entity set is small, so that a single incidental entity match in a short user input 64 does not produce a spuriously high input ratio. In one embodiment, the minimum-match guard requires that |M| be greater than or equal to a minimum-match threshold, such as a minimum-match threshold of approximately two in one embodiment, before the input ratio is eligible to be selected. When |M| is below the minimum-match threshold, the maximum selector with minimum-match guard 94 selects the context ratio without considering the input ratio. When |M| meets or exceeds the minimum-match threshold, the maximum selector with minimum-match guard 94 selects the larger of the context ratio and the input ratio. In the illustrative example of FIG. 3, with a context ratio of approximately 0.025 and an input ratio of approximately 0.833, the entity overlap signal 82 is approximately 0.83.

The dual-ratio scoring subsystem 80 addresses an asymmetric overlap problem that arises in semantic leak detection. The reference context 62 supplied by an enterprise LLM-powered application is typically substantially longer than the user input 64, often by one or more orders of magnitude. A symmetric overlap metric, such as a Jaccard coefficient or a Dice coefficient, that compares the intersection of two sets against the union or the average of the two sets, would severely undercount a concentrated leak in which a small number of named entities are extracted from a large reference context 62. By selecting the maximum of a context-anchored ratio and an input-anchored ratio, the dual-ratio scoring subsystem 80 produces a high entity overlap signal 82 in both the verbatim-reproduction case, in which the context ratio is large, and the concentrated-extraction case, in which the input ratio is large. The minimum-match guard ensures that the input-anchored ratio cannot be inflated by a single incidental match between a short user input 64 and a long reference context 62, which preserves the precision of the entity overlap signal 82 in cases in which the user input 64 happens to mention a common entity that also appears in the reference context 62.

The dual-ratio scoring subsystem 80 is described above in connection with sets of named entities produced by an NER pipeline. The same dual-ratio scoring formulation applies to other set-valued signal extractors in the system 10. In particular, the number match extractor 20 of FIG. 1 employs an analogous dual-ratio scoring subsystem in which the context entity set 84 is replaced by a set of normalized numerical patterns extracted from the reference context 62, the input entity set 86 is replaced by a set of normalized numerical patterns extracted from the user input 64, the fuzzy matcher 88 is replaced by an exact-match comparator on canonicalized numerical patterns, and the minimum-match guard is applied in a corresponding manner. The dual-ratio scoring formulation is generally applicable to any signal extractor that produces a set of discrete elements from each of the reference context 62 and the user input 64 and that requires robustness to asymmetric input lengths.

### § 1.3 Number and Pattern Matching

Returning to FIG. 1, the number match extractor 20 is implemented in one embodiment as a number and pattern matching subsystem that produces a number match signal representing an asymmetric overlap between a set of normalized numerical patterns extracted from the reference context 62 and a set of normalized numerical patterns extracted from the user input 64. The number and pattern matching subsystem includes a pattern extractor, a canonical normalizer, a word-to-digit converter, a magnitude-suffix separator, and a dual-ratio scorer.

The number match signal has high per-signal precision in the context of semantic leak detection. A specific numerical value, such as a monetary amount, a percentage, a date, a network port number, or a software version string, is rarely identical between an arbitrary user input 64 and an arbitrary reference context 62 by coincidence. When the same specific numerical value appears in both the user input 64 and the reference context 62, the value is a strong indicator that the user input 64 reproduces, paraphrases, or summarizes content from the reference context 62. The number match extractor 20 is therefore particularly effective against direct quotation, fact extraction, and numerical data leak attack patterns, in which a user reproduces specific figures drawn from a sensitive reference context 62.

The pattern extractor receives the reference context 62 and the user input 64 in preprocessed canonical form from the request validator 16 and extracts a set of structured numerical patterns from each of the reference context 62 and the user input 64. The pattern extractor applies a plurality of regular expressions targeting a plurality of structured pattern types. In one embodiment, the structured pattern types include monetary amounts with one or more currency symbols, percentages, dates in a plurality of formats including an International Organization for Standardization (ISO) 8601 format, a United States month-day-year format, a European day-month-year format, and a quarterly fiscal-period format, uniform resource locator (URL) paths and application programming interface (API) endpoint paths, network port numbers, software version strings, and Internet Protocol version 4 (IPv4) addresses. The pattern extractor may further extract additional structured pattern types, such as Internet Protocol version 6 (IPv6) addresses, telephone numbers, identification numbers, transaction identifiers, hash values, geographic coordinates, and other structured tokens that may appear in sensitive enterprise content.

The canonical normalizer receives each extracted numerical pattern from the pattern extractor and produces a canonical form for the extracted numerical pattern, so that two numerical patterns representing the same underlying value, but written in different surface forms, are treated as equivalent. The canonical normalizer supports a plurality of international number formats. In one embodiment, the canonical normalizer supports at least five international number formats, including a United States format that uses a comma as a thousands separator and a period as a decimal separator, such as $14,200,000.50, a European format that uses a period as a thousands separator and a comma as a decimal separator, such as 14.200.000,50, an Indian format that applies lakh and crore grouping with mixed two-digit and three-digit groups, such as 1,42,00,000.50, an Eastern Arabic numeral format that uses code points in the Unicode range U+0660 through U+0669 in lieu of Latin digit code points U+0030 through U+0039, and a Chinese-Japanese-Korean (CJK) fullwidth digit format that uses code points in the Unicode range U+FF10 through U+FF19 in lieu of Latin digit code points. The canonical normalizer may further support additional international number formats and writing systems, such as Devanagari digit code points in the Unicode range U+0966 through U+096F, Thai digit code points in the Unicode range U+0E50 through U+0E59, or Bengali digit code points in the Unicode range U+09E6 through U+09EF.

The canonical normalizer applies a last-separator heuristic to disambiguate a separator character that may serve as either a thousands separator or a decimal separator. In one embodiment, when a numerical pattern contains a plurality of period characters, a plurality of comma characters, or a mixed sequence of period and comma characters, the last occurrence of a separator character in the numerical pattern is treated as the decimal separator and any earlier occurrences of separator characters are treated as thousands separators. The last-separator heuristic correctly disambiguates the pattern 14.200.000,50 as a European-format number with a decimal value of 0.50, the pattern 14,200,000.50 as a United States-format number with a decimal value of 0.50, and the pattern 1,42,00,000.50 as an Indian-format number with a decimal value of 0.50, without requiring an explicit declaration of the number format associated with the surrounding text.

The canonical normalizer further applies one or more transliteration tables to convert non-Latin digit code points into a canonical Latin digit representation. In one embodiment, the canonical normalizer applies an Eastern Arabic transliteration table that maps each code point in the Unicode range U+0660 through U+0669 to a corresponding Latin digit code point in the Unicode range U+0030 through U+0039, and applies a CJK fullwidth transliteration table that maps each code point in the Unicode range U+FF10 through U+FF19 to a corresponding Latin digit code point in the Unicode range U+0030 through U+0039. The transliteration tables ensure that a numerical value expressed in Eastern Arabic numerals or in CJK fullwidth digits in the reference context 62 is matched against the same numerical value expressed in Latin digits in the user input 64, and vice versa, which addresses a cross-script paraphrase attack pattern.

The word-to-digit converter converts word-form representations of numerical values into canonical digit representations. The word-to-digit converter receives the reference context 62 and the user input 64 in preprocessed canonical form and produces a transformed version of the reference context 62 and the user input 64 in which word-form numbers have been replaced by digit-form numbers. In one embodiment, the word-to-digit converter maps a phrase such as “fourteen point two million” to the canonical string “14.2 million,” maps the phrase “two hundred and fifty” to the canonical string “250” by recognizing the “and” connector as part of the word-form number rather than as a conjunction, and maps the phrase “one and a half percent” to the canonical string “1.5%.” The word-to-digit converter enables the number match extractor 20 to detect a leak in which a numerical value present in digit form in the reference context 62 is reproduced in word form in the user input 64, or vice versa, which is a common paraphrase pattern observed in semantic leak attacks.

The magnitude-suffix separator separates a magnitude suffix from an adjacent numerical value when the magnitude suffix is concatenated with the numerical value without an intervening whitespace character. The magnitude-suffix separator splits a concatenated form such as $320M into the separated form $320 M, splits 12.5 K into 12.5 K, and splits 4.2 B into 4.2 B, so that downstream regular expressions of the pattern extractor correctly capture the numeric portion of each numerical pattern. In one embodiment, the magnitude-suffix separator supports magnitude suffixes including the letter K for thousands, the letter M for millions, the letter B for billions, and the letter T for trillions, and may further support locale-specific magnitude suffixes including lakh and crore for the Indian numbering system. The magnitude-suffix separator operates before the pattern extractor applies its regular expressions, or as a preprocessing step within the pattern extractor, depending on the embodiment.

The dual-ratio scorer receives a context number set extracted from the reference context 62 and an input number set extracted from the user input 64, each in canonicalized form following processing by the canonical normalizer, the word-to-digit converter, and the magnitude-suffix separator, and produces the number match signal. The dual-ratio scorer of the number match extractor 20 implements an embodiment of the dual-ratio scoring subsystem 80 of FIG. 3, with the context entity set 84 of FIG. 3 replaced by the context number set, with the input entity set 86 of FIG. 3 replaced by the input number set, and with the fuzzy matcher 88 of FIG. 3 replaced by an exact-match comparator that operates on the canonicalized numerical patterns. The dual-ratio scorer computes a context-anchored ratio according to Equation (5):

ctx_ratio_num=|M_num|/|N_ctx| (5)

in which |M_num| is the cardinality of a matched number set including canonical numerical patterns present in both the context number set and the input number set, and |N_ctx| is the cardinality of the context number set. The dual-ratio scorer further computes an input-anchored ratio according to Equation (6):

inp_ratio_num=|M_num|/|N_inp| (6)

in which |N_inp| is the cardinality of the input number set. The dual-ratio scorer produces the number match signal according to Equation (7):

C=Max(ctx_ratio_num, inp_ratio_num) (7)

subject to a minimum-match guard that requires |M_num| to be greater than or equal to a minimum-match threshold, such as a minimum-match threshold of approximately two in one embodiment, before the input-anchored ratio is eligible to be selected.

The minimum-match guard applied by the dual-ratio scorer is particularly important for the number match signal because individual numerical values may appear in the user input 64 by coincidence even in the absence of a leak. By way of illustration, a calendar year such as 2026, a small integer such as 1, 2, or 3, or a common percentage such as 100% may appear in the user input 64 without being copied from the reference context 62. The minimum-match guard ensures that a single coincidental numerical match does not produce a spuriously high number match signal.

The number match signal produced by the number match extractor 20 is provided to the weighted fusion module 32 of FIG. 1 as the third primary signal of the weighted linear combination, and is further evaluated by the confidence router 34 of FIG. 1 in connection with one or more bypass conditions. In particular, when the number match signal exceeds an upper bypass threshold and the cosine similarity score 52 exceeds a lower corroboration threshold, the confidence router 34 may apply a strong number match bypass that produces a trigger decision without invocation of the cross-encoder 38 of FIG. 1, as described further in connection with a subsequent figure. The number match signal is also one of a plurality of precision-support inputs evaluated by the no-data guard module 36 of FIG. 1 to determine whether precision-support evidence exists for a trigger decision produced by the cross-encoder 38.

The number match extractor 20 captures a class of semantic leak patterns that are particularly difficult to detect using bi-encoder cosine similarity alone. A short user input 64 that reproduces a specific monetary amount, a specific percentage, a specific date, or a specific technical identifier from the reference context 62 may have only moderate cosine similarity to the reference context 62, because the bi-encoder of FIG. 2 captures broad semantic content and may not assign disproportionate weight to a single numerical token. The number match signal, in contrast, is highly sensitive to the reproduction of specific numerical values, and complements the cosine similarity score 52 by providing high-precision evidence of numerical leakage that the cosine similarity score 52 alone would not provide.

### § 1.4 Code Similarity

Returning to FIG. 1, the code similarity extractor 30 is implemented in one embodiment as a code similarity subsystem that produces a code similarity signal representing a token-level overlap between source code, configuration data, or other code-like content present in the reference context 62 and source code, configuration data, or other code-like content present in the user input 64. The code similarity subsystem includes a code gate and a token coverage scorer.

The code similarity extractor 30 addresses a class of semantic leak patterns that are not adequately captured by the bi-encoder 24, the entity NER extractor 26, or the number match extractor 20 of FIG. 1. When a reference context 62 contains source code, configuration files, scripts, query language statements, or similar code-like content, and a user input 64 reproduces a fragment of that code-like content, several detection challenges arise. First, the cosine similarity score 52 produced by the bi-encoder 24 may be diluted when a code fragment is embedded in surrounding prose, because the bi-encoder 24 is trained primarily on natural language text and may not assign disproportionate weight to short code fragments. Second, the entity overlap signal produced by the entity NER extractor 26 may be near zero, because identifiers such as function names, variable names, and configuration keys are typically not recognized as named entities by an NER model trained on natural language. Third, the number match signal produced by the number match extractor 20 may be near zero, because a reproduced code fragment may not contain any of the structured numerical pattern types recognized by the pattern extractor. The code similarity extractor 30 supplies a high-precision signal that addresses these gaps.

The code gate receives the user input 64 in preprocessed canonical form and determines whether the user input 64 contains code-like content. The code gate applies a plurality of regular expression patterns directed at structural and lexical features that are characteristic of source code, configuration data, or query language statements, but that are uncommon in ordinary natural language prose. In one embodiment, the regular expression patterns of the code gate include a curly brace and semicolon pattern that detects the presence of structural punctuation characteristic of curly-brace languages, a language keyword pattern that detects keywords drawn from a set including def, class, function, return, import, include, const, var, and let, a multi-character operator pattern that detects operators drawn from a set including the arrow operator, the fat-arrow operator, the scope resolution operator, and the range operator, a preprocessor directive pattern that detects directives drawn from a set including #include, #define, and #ifdef, an output call pattern that detects standard library output calls drawn from a set including printf, println, and console.log, a structured query language (SQL) keyword pattern that detects SQL keywords drawn from a set including SELECT, FROM, WHERE, JOIN, INSERT, UPDATE, and DELETE, a function definition pattern that detects function signature syntax, a string literal pattern that detects quoted string literals with embedded escape sequences, and an assignment pattern that detects assignment operators within an identifier-bearing expression.

The code gate produces an activation decision based on a count of independent regular expression patterns that match the user input 64. In one embodiment, the code gate activates the token coverage scorer when the count of matching patterns is greater than or equal to a configurable minimum indicator threshold, such as a minimum indicator threshold of approximately two in one embodiment. The minimum indicator threshold reduces false activation of the code gate by isolated occurrences of a single pattern that may arise incidentally in natural language prose, such as a single semicolon in a long sentence, a single occurrence of the word “function” in a discussion of mathematics or biology, or a single occurrence of an SQL keyword in a discussion of database design. Requiring a plurality of independent indicators ensures that the code gate activates only when the user input 64 contains content that is unambiguously code-like.

The token coverage scorer receives the reference context 62 and the user input 64 in preprocessed canonical form, conditioned on activation of the code gate, and produces the code similarity signal. The token coverage scorer applies a code-oriented tokenizer that segments each of the reference context 62 and the user input 64 into a sequence of code tokens. In one embodiment, the code-oriented tokenizer extracts tokens matching a token regular expression that captures (a) identifier tokens having the form of an initial letter or underscore followed by zero or more word characters, (b) multi-character punctuation operator tokens of length two or more characters, and (c) numeric literal tokens consisting of digit characters. The code-oriented tokenizer treats whitespace as a token separator and applies a whitespace normalization step that collapses consecutive whitespace characters into a single separator, so that surface variations in indentation, alignment, and line spacing do not produce spurious token differences between the reference context 62 and the user input 64.

The token coverage scorer computes the code similarity signal as a fraction of input code tokens of the user input 64 that also appear in the set of code tokens extracted from the reference context 62. The code similarity signal is computed according to Equation (8):

E=|T_matched|/|T_inp| (8)

in which E denotes the code similarity signal, |T_matched| denotes the cardinality of a matched code token set including code tokens of the user input 64 that also appear in the reference context 62, and |T_inp| denotes the cardinality of a code token set extracted from the user input 64. The code similarity signal takes a value in the range from approximately zero to approximately one, with a value of approximately one indicating that substantially every code token of the user input 64 appears in the reference context 62.

The token coverage scorer applies an input-anchored coverage formulation rather than a symmetric overlap metric, such as a Jaccard coefficient or a Dice coefficient. The input-anchored coverage formulation is selected in preference to a symmetric metric because the reference context 62 frequently contains substantial non-code natural language prose, such as commentary, documentation, or explanatory text surrounding a code fragment, that inflates the union of tokens used in the denominator of a symmetric metric without reducing the input's code token presence. By anchoring the denominator on the user input 64, the token coverage scorer produces a high code similarity signal whenever the user input 64 reproduces code tokens drawn from the reference context 62, regardless of the size or composition of the surrounding non-code content of the reference context 62.

High-precision code tokens contribute disproportionately to the code similarity signal in practice. Code tokens such as user-defined identifiers, function names, API keys, configuration field names, query field names, and authentication endpoint names are typically unique to a specific reference context 62. When the user input 64 reproduces one or more such high-precision code tokens, the code similarity signal provides strong evidence of reproduction even in the absence of any matched natural language content. By way of illustration, a user input 64 that reproduces an identifier such as authenticate_user from a reference context 62 that defines that function provides strong evidence of code reproduction, even though no named entity match, no number match, and only moderate cosine similarity may be present.

The code similarity signal produced by the code similarity extractor 30 is provided to the no-data guard module 36 of FIG. 1 as a precision-support input. The code similarity signal does not participate in the weighted linear combination computed by the weighted fusion module 32. The code similarity signal instead provides precision support that the no-data guard module 36 considers when determining whether a trigger decision produced by the confidence router 34 or by the cross-encoder 38 is supported by sufficient precision-bearing evidence. In one embodiment, the code similarity signal contributes precision support when the code similarity signal is greater than or equal to a precision-support threshold, such as a precision-support threshold of approximately 0.80 in one embodiment.

The code similarity extractor 30 is not limited to source code in any particular programming language or to configuration data in any particular file format. The regular expression patterns of the code gate and the token regular expression of the code-oriented tokenizer are configurable, and may be adapted to cover additional programming languages, additional configuration file formats, additional query languages, additional markup languages, and additional structured data formats. In one embodiment, the regular expression patterns are loaded from a configuration store at startup of the system 10 and may be updated independently of the underlying machine learning models, so that the system 10 may be extended to recognize additional code-like patterns over time without requiring retraining or redeployment of the bi-encoder 24, the entity NER extractor 26, or the cross-encoder 38.

The code similarity extractor 30, by being gated on a multi-indicator code detector and by being applied only when the code gate activates, does not contribute to the code similarity signal for ordinary natural language inputs. When the code gate does not activate, the code similarity signal evaluates to zero and the code similarity signal contributes no precision support to the no-data guard module 36. This gated architecture prevents false precision support in cases in which the user input 64 happens to share a small number of natural language tokens with the reference context 62 that, under a code-oriented tokenizer, might appear to be code tokens. The code gate ensures that the code similarity extractor 30 is specific to genuine code-like content.

### § 1.5 Text Token Overlap

Returning to FIG. 1, the text overlap extractor 28 is implemented in one embodiment as a text token overlap subsystem that produces a text token overlap signal representing a content-token reproduction relationship between the reference context 62 and the user input 64. The text token overlap subsystem includes a content-token tokenizer, a stopword filter, a request-word filter, and a coverage-and-specificity scorer.

The text overlap extractor 28 addresses a class of semantic leak patterns that are not adequately captured by the bi-encoder 24, the entity NER extractor 26, the number match extractor 20, or the code similarity extractor 30 of FIG. 1. When the user input 64 reproduces content-bearing tokens from a reference context 62 that contains no recognizable named entities, no structured numerical patterns, and no code-like content, each of the precision-support signals provided by the entity NER extractor 26, the number match extractor 20, and the code similarity extractor 30 evaluates to zero. In such a case, the no-data guard module 36 of FIG. 1 would otherwise block a trigger decision for lack of precision-support evidence, even when the cosine similarity score 52 produced by the bi-encoder 24 and a cross-encoder score produced by the cross-encoder 38 both indicate that a genuine reproduction has occurred. By way of illustration, a reference context 62 that recites that an infrastructure audit shows a vulnerability with a low risk level, paired with a user input 64 that recites that the finding shows a low risk, presents a genuine reproduction in which entity overlap evaluates to zero and number match evaluates to zero, but content-bearing tokens of the reference context 62 are reproduced in the user input 64. The text overlap extractor 28 supplies a precision-support signal that addresses this gap.

The content-token tokenizer receives the reference context 62 and the user input 64 in preprocessed canonical form and produces a set of content-bearing tokens from each. In one embodiment, the content-token tokenizer extracts alphanumeric tokens having a minimum length, such as a minimum length of approximately two characters in one embodiment, and discards tokens shorter than the minimum length. The content-token tokenizer applies a case-folding step that normalizes each token to a common case, such as a lower-case form, so that surface variations in capitalization do not produce spurious token differences. The content-token tokenizer treats whitespace and punctuation as token separators.

The stopword filter receives the set of content-bearing tokens produced by the content-token tokenizer for each of the reference context 62 and the user input 64, and removes a predefined set of stopwords from each set. The stopwords are universal function words that contribute little to the semantic content of either the reference context 62 or the user input 64 and that, if retained, would dominate token overlap statistics regardless of whether a reproduction has occurred. In one embodiment, the stopwords include articles, prepositions, conjunctions, and other high-frequency function words drawn from a set that includes the words a, an, the, is, are, was, were, be, been, being, of, at, by, for, with, and, or, but, to, in, on, from, as, this, that, these, and those. The stopword filter operates on both the context-side token set and the input-side token set, so that a stopword present in only one of the two sets does not contribute to either the matched token count or the cardinality of either set.

The request-word filter receives the input-side token set following stopword removal and removes a predefined set of request words from the input-side token set only. The request-word filter operates on the input side only and not on the context side, because request words are characteristic of meta-instructions that a user issues to an LLM-powered application rather than of content drawn from the reference context 62. In one embodiment, the request words include meta-verbs drawn from a set that includes the words summarize, explain, describe, provide, list, extract, draft, write, create, generate, document, and report, and may further include corresponding nominal and gerundive forms such as summary, explanation, description, listing, extraction, drafting, writing, creation, generation, documentation, and reporting. The asymmetric application of the request-word filter, with the request-word filter operating only on the input side, prevents a request-style user input 64 from registering a spuriously high coverage score against a reference context 62 that happens to contain the same request words as content.

The coverage-and-specificity scorer receives the filtered content-bearing token sets for the reference context 62 and the user input 64 and produces the text token overlap signal as a product of a coverage component and a specificity component. The coverage component is computed according to Equation (9):

coverage=|T_matched_content|/|T_inp_content| (9)

in which |T_matched_content| denotes the cardinality of a matched content-token set including content-bearing tokens present in both the filtered context-side token set and the filtered input-side token set, and |T_inp_content| denotes the cardinality of the filtered input-side token set. The specificity component is computed according to Equation (10):

specificity=|T_matched_content|/|T_ctx_content| (10)

in which |T_ctx_content| denotes the cardinality of the filtered context-side token set. The coverage-and-specificity scorer produces the text token overlap signal according to Equation (11):

F=coverage×specificity (11)

in which F denotes the text token overlap signal.

The product formulation of Equation (11) is a deliberate design choice that distinguishes the text token overlap signal from a coverage-only metric and from a symmetric overlap metric. A coverage-only metric, computed as the fraction of input-side content-bearing tokens that appear in the reference context 62, evaluates to approximately one for a short request-style user input 64 against a long reference context 62, because substantially every content-bearing token of the short user input 64 appears somewhere in the long reference context 62 by virtue of the size of the reference context 62. A coverage-only metric is therefore prone to false-positive precision support against summarize-style or extract-style user inputs 64. A symmetric overlap metric, such as a Jaccard coefficient, is dominated by the cardinality of the larger of the two token sets and is therefore prone to false-negative precision support against concentrated reproductions in which a short user input 64 reproduces content from a long reference context 62.

The product formulation addresses both failure modes. The specificity component approaches zero when the reference context 62 is substantially larger than the user input 64 and contains content unrelated to the user input 64, because the matched content-token count is small relative to the cardinality of the filtered context-side token set, even when the coverage component approaches one. The product of a coverage component near one and a specificity component near zero remains small, so that a summarize-style request against a long reference context 62 does not produce a high text token overlap signal. Conversely, the coverage component approaches one when the user input 64 reproduces content drawn from the reference context 62, and the specificity component takes a moderate value when the reference context 62 is short and substantially focused on the same content as the user input 64. The product of a coverage component near one and a moderate specificity component takes a value sufficient to indicate genuine content reproduction.

By way of illustration, consider a reference context 62 reciting that an infrastructure audit shows a vulnerability with a low risk level, paired with a user input 64 reciting that the finding shows a low risk. After application of the content-token tokenizer, the stopword filter, and the request-word filter, the filtered context-side token set includes the tokens infrastructure, audit, shows, vulnerability, low, and risk, and the filtered input-side token set includes the tokens finding, shows, low, and risk. The matched content-token set includes the tokens shows, low, and risk, with a cardinality of three. The coverage component is approximately 0.75, the specificity component is approximately 0.50, and the text token overlap signal is approximately 0.38. By contrast, consider a user input 64 reciting “summarize the document for me” paired with a long reference context 62 that contains the tokens summarize, document, and me among many other content-bearing tokens. After application of the request-word filter to the input side, the request words summarize and document are removed from the input-side token set, and the resulting filtered input-side token set is empty or near empty, producing a text token overlap signal at or near zero.

The text token overlap signal is provided to the no-data guard module 36 of FIG. 1 as a precision-support input. The text token overlap signal does not participate in the weighted linear combination computed by the weighted fusion module 32. The text token overlap signal instead provides precision support that the no-data guard module 36 considers when determining whether a trigger decision produced by the confidence router 34 or by the cross-encoder 38 is supported by sufficient precision-bearing evidence. In one embodiment, the text token overlap signal contributes precision support when the text token overlap signal is greater than or equal to a precision-support threshold, such as a precision-support threshold of approximately 0.20 in one embodiment.

The text overlap extractor 28 is configured to behave gracefully in cross-script and cross-lingual scenarios. In one embodiment, when the content-token tokenizer produces an empty input-side token set or an empty context-side token set, the text token overlap signal evaluates to zero and the text overlap extractor 28 contributes no precision support to the no-data guard module 36. This case may arise, for example, when the user input 64 is expressed in a non-Latin script for which the content-token tokenizer is not configured. In such a case, the cosine similarity score 52 produced by the bi-encoder 24 and the cross-encoder score produced by the cross-encoder 38 remain available to support a detection decision, and the absence of text token overlap precision support is offset by the language-tier weighting profile applied by the weighted fusion module 32, which assigns increased weight to the cosine similarity score 52 for lower-resource languages.

The stopword set and the request-word set are configurable and may be adapted for additional natural languages, additional content domains, and additional request styles. In one embodiment, the stopword set and the request-word set are loaded from a configuration store at startup of the system 10 and may be updated independently of the underlying machine learning models. The text overlap extractor 28 may further apply language-specific stopword sets and language-specific request-word sets selected based on the language code produced by the language detector 22.

### § 1.6 Tier-Adaptive Weighted Fusion

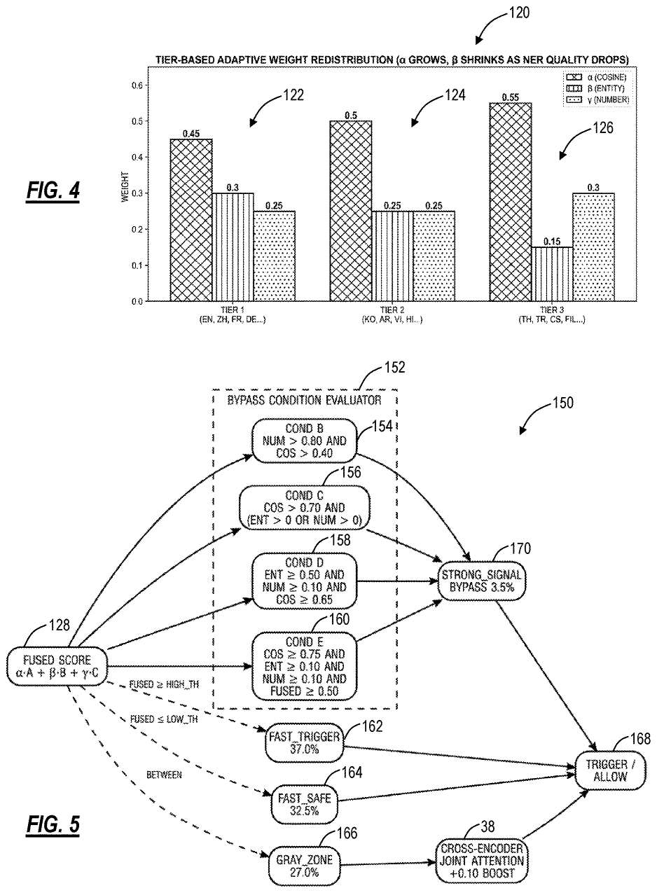

FIG. 4 is a bar chart illustrating a tier-based adaptive weight redistribution scheme 120 implemented by the weighted fusion module 32 of FIG. 1 according to an embodiment of the present disclosure. The tier-based adaptive weight redistribution scheme 120 includes a plurality of language-tier weight profiles, in which each language-tier weight profile specifies a respective set of fusion weights to be applied by the weighted fusion module 32 when the language code produced by the language detector 22 of FIG. 1 matches one of a plurality of languages associated with the language-tier weight profile. In the embodiment of FIG. 4, the tier-based adaptive weight redistribution scheme 120 includes three language-tier weight profiles, including a first tier profile 122 associated with a first set of natural languages, a second tier profile 124 associated with a second set of natural languages, and a third tier profile 126 associated with a third set of natural languages.

The weighted fusion module 32 receives the cosine similarity score 52 produced by the bi-encoder 24, the entity overlap signal 82 produced by the entity NER extractor 26, and the number match signal produced by the number match extractor 20, and combines the three signals into a fused score 128 (FIG. 5) according to a weighted linear combination, as set forth in Equation (12):

fused=α·A+β·B+γ·C (12)

in which A denotes the cosine similarity score 52, B denotes the entity overlap signal 82, C denotes the number match signal, α denotes a cosine weight, β denotes an entity weight, γ denotes a number weight, and the weights α, β, and γ are non-negative real numbers that sum to unity. The weights α, β, and γ are selected from one of the plurality of language-tier weight profiles based on the language code produced by the language detector 22. The fused score 128 takes a value in a range from approximately zero to approximately one.

The first tier profile 122 corresponds to a first language tier including natural languages for which a dedicated language-specific NER model is available with a relatively high named entity recognition F1 score, and for which the cross-encoder 38 of FIG. 1 has been trained on a corresponding language-specific subset of a multilingual passage-ranking corpus. The first language tier includes high-resource languages with mature natural language processing tooling, such as English (EN), Chinese (ZH), Dutch (NL), French (FR), German (DE), Italian (IT), Japanese (JA), Portuguese (PT), Russian (RU), and Spanish(ES) in one embodiment. The first tier profile 122 assigns a cosine weight α of approximately 0.45, an entity weight β of approximately 0.30, and a number weight γ of approximately 0.25, as illustrated in FIG. 4.

The second tier profile 124 corresponds to a second language tier including natural languages for which a dedicated language-specific NER model is available with a moderate named entity recognition F1 score, and for which the cross-encoder 38 has partial coverage of the corresponding multilingual passage-ranking corpus. The second language tier includes intermediate-resource languages, such as Danish (DA), Greek (EL), Korean (KO), Norwegian (NO), Polish (PL), Swedish (SV), Arabic (AR), Indonesian (ID), Vietnamese (VI), and Hindi (HI) in one embodiment. The second tier profile 124 assigns a cosine weight α of approximately 0.50, an entity weight β of approximately 0.25, and a number weight γ of approximately 0.25, as illustrated in FIG. 4. Relative to the first tier profile 122, the second tier profile 124 increases the cosine weight α and decreases the entity weight β, reflecting the lower expected reliability of named entity recognition for natural languages in the second language tier.

The third tier profile 126 corresponds to a third language tier including natural languages for which no dedicated language-specific NER model is available and for which a multilingual fallback NER model is used in lieu of a dedicated model. The third language tier includes lower-resource languages, such as Afrikaans (AF), Czech (CS), Filipino (FIL), Hebrew (HE), Malay (MS), Swahili (SW), Thai (TH), and Turkish (TR) in one embodiment. The third tier profile 126 assigns a cosine weight α of approximately 0.55, an entity weight β of approximately 0.15, and a number weight γ of approximately 0.30, as illustrated in FIG. 4. Relative to the second tier profile 124, the third tier profile 126 further increases the cosine weight α, further decreases the entity weight β, and increases the number weight γ, reflecting the still lower expected reliability of named entity recognition for natural languages in the third language tier and the substantially language-agnostic character of the structured numerical patterns recognized by the number match extractor 20.

The progression of fusion weights across the first tier profile 122, the second tier profile 124, and the third tier profile 126 reflects an underlying observation that named entity recognition quality degrades from a first language tier of high-resource natural languages to a third language tier of lower-resource natural languages, while bi-encoder cosine similarity and number and pattern matching are comparatively language-agnostic. By increasing the cosine weight α and decreasing the entity weight β as the expected reliability of named entity recognition decreases, the tier-based adaptive weight redistribution scheme 120 maintains substantially uniform detection quality across natural languages without requiring a separate trained model for each natural language and without introducing per-language retraining overhead. In experimental evaluation, the tier-based adaptive weight redistribution scheme 120 produces a per-language F1 standard deviation on the order of a few thousandths across twenty-six natural languages, which is unusually low for a production multilingual natural language processing system.

The weighted fusion module 32 may further include a weight redistribution unit that reallocates fusion weights when one or more of the signals A, B, or C evaluates to a substantially zero value. In one embodiment, when the entity overlap signal 82 evaluates to substantially zero, the weight redistribution unit redistributes the entity weight β proportionally to the cosine weight α and the number weight γ, producing an adjusted cosine weight α and an adjusted number weight γ that, together with a zero entity weight, sum to unity. When the number match signal evaluates to substantially zero, the weight redistribution unit redistributes the number weight γ proportionally to the cosine weight α and the entity weight β. When both the entity overlap signal 82 and the number match signal evaluate to substantially zero, the weight redistribution unit sets the cosine weight α to unity, the entity weight β to zero, and the number weight γ to zero, so that the fused score 128 reduces to the cosine similarity score 52. The weight redistribution unit operates after the tier-based selection of fusion weights, so that the redistribution is applied to the tier-specific weights selected for the detected language.

The substantially-zero condition that triggers weight redistribution may be defined in any of several ways without departing from the scope of the disclosure. In one embodiment, the substantially-zero condition is defined as an exact zero value of the corresponding signal. In another embodiment, the substantially-zero condition is defined as a signal value below a small redistribution threshold, such as a redistribution threshold of approximately 0.01 in one embodiment, so that a signal value that is numerically near zero but not exactly zero, for example as a result of floating-point rounding or a single incidental match below the minimum-match guard, is treated as zero for purposes of weight redistribution.

The tier-based adaptive weight redistribution scheme 120 is further configurable along several dimensions. The number of language-tier weight profiles is not limited to three and may be increased to provide finer-grained adaptation, such as four, five, or more language-tier weight profiles in alternative embodiments. The membership of each language tier is not limited to the natural languages enumerated above and may be adjusted based on empirical measurement of named entity recognition F1 score, on cross-encoder corpus coverage, on data loss prevention deployment priorities, or on customer-specific language coverage requirements. The fusion weights α, β, and γ within each language-tier weight profile are not limited to the specific values illustrated in FIG. 4 and may be tuned through validation on a labeled evaluation corpus. In one embodiment, the fusion weights and the language-tier memberships are stored in a configuration store and are reloadable independently of the underlying machine learning models, so that the system 10 may be adapted to new natural languages, to updated NER models, or to evolving deployment priorities without retraining or redeployment of the bi-encoder 24, the entity NER extractor 26, the number match extractor 20, or the cross-encoder 38.

The weighted linear combination of Equation (12) is not the only fusion formulation contemplated by the present disclosure. In alternative embodiments, the weighted fusion module 32 may implement a non-linear fusion formulation, such as a logistic regression on the signals A, B, and C, a gradient-boosted decision tree, a small feed-forward neural network, or a learned attention mechanism, in which the tier-based adaptive weight redistribution scheme 120 is replaced by a tier-based selection among a plurality of learned fusion functions. The weighted linear combination is preferred in the illustrated embodiment because it is inspectable, deterministic, and amenable to configuration without retraining, and because the per-signal precision and recall characteristics established by the precision-support, corroboration, and bypass mechanisms enable a linear combination to achieve substantially uniform detection quality across natural languages.

The fused score 128 produced by the weighted fusion module 32 is provided to the confidence router 34 of FIG. 1, which directs the input text 12 onto one of a plurality of decision paths based on the fused score 128 and on one or more bypass conditions, as described further in connection with a subsequent figure.

### § 1.7 Confidence Router With Bypass Conditions

FIG. 5 is a diagram of a confidence routing subsystem 150 according to an embodiment of the present disclosure. The confidence routing subsystem 150 is an embodiment of the confidence router 34 of FIG. 1 and directs the input text 12 onto one of a plurality of decision paths based on the fused score 128 produced by the weighted fusion module 32 and on a plurality of bypass conditions evaluated in parallel with the fused score 128. The confidence routing subsystem 150 includes a bypass condition evaluator 152 that evaluates a strong number match bypass 154, a high-cosine corroboration bypass 156, a multi-signal convergence bypass 158, and a weak convergence bypass 160, and further includes a fast trigger path 162, a fast safe path 164, and a gray zone path 166 selected based on a comparison of the fused score 128 to a high threshold and to a low threshold. The fast trigger path 162, the fast safe path 164, the gray zone path 166, the strong number match bypass 154, the high-cosine corroboration bypass 156, the multi-signal convergence bypass 158, and the weak convergence bypass 160 each terminate at a trigger or allow decision 168 that produces the leak or safe verdict 14 of FIG. 1, while the gray zone path 166 invokes the cross-encoder 38 of FIG. 1 before reaching the trigger or allow decision 168.

The confidence routing subsystem 150 implements a multi-stage classification strategy that selectively invokes the computationally expensive cross-encoder 38 only when the fused score 128, supplemented by the bypass conditions, does not produce a confident classification. In experimental evaluation, the confidence routing subsystem 150 directs approximately seventy-three percent of input text 12 traffic onto the fast trigger path 162, the fast safe path 164, or one of the strong-signal bypass paths, with the remaining approximately twenty-seven percent of traffic routed through the gray zone path 166 and the cross-encoder 38. The selective invocation of the cross-encoder 38 reduces average end-to-end latency relative to a configuration in which the cross-encoder 38 is invoked for every input text 12.

The fast trigger path 162 is selected when the fused score 128 is greater than or equal to a tier-specific high threshold associated with the language tier of the input text 12, subject to a precision-support requirement enforced by the no-data guard module 36 of FIG. 1. The tier-specific high threshold is selected based on the language code produced by the language detector 22 of FIG. 1, and takes a value such as approximately 0.75 for a first language tier, approximately 0.72 for a second language tier, and approximately 0.70 for a third language tier in one embodiment. When the fast trigger path 162 is selected and precision-support evidence is present, the trigger or allow decision 168 produces a trigger verdict without invocation of the cross-encoder 38.

The fast safe path 164 is selected when the fused score 128 is less than or equal to a tier-specific low threshold associated with the language tier of the input text 12. The tier-specific low threshold takes a value such as approximately 0.45 for a first language tier, approximately 0.42 for a second language tier, and approximately 0.40 for a third language tier in one embodiment. When the fast safe path 164 is selected, the trigger or allow decision 168 produces an allow verdict without invocation of the cross-encoder 38.

The gray zone path 166 is selected when the fused score 128 is between the tier-specific low threshold and the tier-specific high threshold and no bypass condition is satisfied. When the gray zone path 166 is selected, the confidence routing subsystem 150 invokes the cross-encoder 38 of FIG. 1, which processes the reference context 62 and the user input 64 jointly through full transformer self-attention and produces a cross-encoder score. The cross-encoder score is compared against a tier-specific cross-encoder threshold, subject to the precision-support requirements enforced by the no-data guard module 36, to produce the trigger or allow decision 168.

The bypass condition evaluator 152 evaluates a plurality of bypass conditions in parallel with the comparison of the fused score 128 to the tier-specific thresholds. The bypass conditions provide alternative paths from the fused score 128 to the trigger or allow decision 168 that account for patterns of signal evidence that the fused score 128 alone, or a single signal alone, would not adequately capture. When any one of the bypass conditions is satisfied, the bypass condition evaluator 152 directs the input text 12 onto a strong-signal bypass path 170 that produces a trigger verdict without invocation of the cross-encoder 38, subject to the precision-support requirements enforced by the no-data guard module 36. In experimental evaluation, the strong-signal bypass path 170 collectively accounts for approximately three and one-half percent of input text 12 traffic.

The strong number match bypass 154, denoted Condition B in FIG. 5, is satisfied when the number match signal exceeds an upper number bypass threshold and the cosine similarity score 52 exceeds a lower corroboration threshold. In one embodiment, the upper number bypass threshold is approximately 0.80 and the lower corroboration threshold is approximately 0.40. The strong number match bypass 154 addresses input text 12 in which precise numerical evidence of reproduction is overwhelming, such as a user input 64 that reproduces a plurality of specific monetary amounts, percentages, or dates from the reference context 62, but in which the entity overlap signal 82 contributes little or no additional evidence, so that the fused score 128 does not reach the tier-specific high threshold. The lower corroboration threshold on the cosine similarity score 52 ensures that the strong number match bypass 154 does not trigger when the user input 64 is unrelated in meaning to the reference context 62 but happens to share one or more numerical patterns by coincidence.

The high-cosine corroboration bypass 156, denoted Condition C in FIG. 5, is satisfied when the cosine similarity score 52 exceeds an upper cosine bypass threshold and at least one of the entity overlap signal 82 and the number match signal is non-zero. In one embodiment, the upper cosine bypass threshold is approximately 0.70. The non-zero requirement on at least one of the entity overlap signal 82 and the number match signal is a corroboration guard that prevents the high-cosine corroboration bypass 156 from triggering on a user input 64 that is topically related to the reference context 62 but does not reproduce any specific entity or numerical pattern. The corroboration guard is significant because, when both the entity overlap signal 82 and the number match signal evaluate to zero, the weight redistribution unit of the weighted fusion module 32 sets the cosine weight α to unity and the fused score 128 reduces to the cosine similarity score 52, so that a high fused score 128 in the absence of corroborating evidence would otherwise indicate only topical similarity rather than reproduction. The corroboration guard ensures that the high-cosine corroboration bypass 156 triggers only when independent precision-support evidence corroborates the cosine similarity score 52.

The multi-signal convergence bypass 158, denoted Condition D in FIG. 5, is satisfied when the entity overlap signal 82 is greater than or equal to a convergence entity threshold, the number match signal is greater than or equal to a convergence number threshold, and the cosine similarity score 52 is greater than or equal to a convergence cosine threshold, all simultaneously. In one embodiment, the convergence entity threshold is approximately 0.50, the convergence number threshold is approximately 0.10, and the convergence cosine threshold is approximately 0.65. The multi-signal convergence bypass 158 addresses a multi-fact synthesis class of semantic leak in which a user input 64 assembles entities, numerical patterns, and contextual meaning drawn from scattered sentences of the reference context 62, with no individual signal exceeding its individual trigger threshold but with simultaneous moderate-strength evidence across all three primary signals. The cross-encoder 38, when trained on a single-sentence passage-ranking corpus, may assign artificially low relevance scores to such multi-fact synthesis leaks because no single passage of the reference context 62 contains all of the reproduced facts. The multi-signal convergence bypass 158 provides an alternative trigger path that captures distributed evidence by requiring simultaneous moderate-strength evidence across all three primary signals.

The weak convergence bypass 160, denoted Condition E in FIG. 5, is satisfied when the cosine similarity score 52 is greater than or equal to a weak convergence cosine threshold, the entity overlap signal 82 is greater than or equal to a weak convergence entity threshold, the number match signal is greater than or equal to a weak convergence number threshold, and the fused score 128 is greater than or equal to a weak convergence fused threshold, all simultaneously. In one embodiment, the weak convergence cosine threshold is approximately 0.75, the weak convergence entity threshold is approximately 0.10, the weak convergence number threshold is approximately 0.10, and the weak convergence fused threshold is approximately 0.50. The weak convergence bypass 160 addresses a class of semantic leak in which the user input 64 reformulates content of the reference context 62 in a colloquial register, using slang, abbreviations, contractions, or informal phrasing, and the cross-encoder 38, when trained on a formal passage-ranking corpus, under-scores the relevance of the user input 64 to the reference context 62 relative to the actual degree of reproduction. The weak convergence bypass 160 requires all four signals to be non-trivially positive, including a non-trivial fused score 128, which prevents the weak convergence bypass 160 from triggering on coincidental low-strength overlaps.

The bypass condition evaluator 152 evaluates the strong number match bypass 154, the high-cosine corroboration bypass 156, the multi-signal convergence bypass 158, and the weak convergence bypass 160 in parallel. When more than one bypass condition is satisfied for a given input text 12, the bypass condition evaluator 152 produces a trigger verdict on the basis of any satisfied bypass condition, and the additional satisfied bypass conditions provide redundant evidence rather than independent contribution. In one embodiment, the bypass condition evaluator 152 records an identification of each satisfied bypass condition in a decision path label that accompanies the leak or safe verdict 14, so that downstream monitoring systems such as a SIEM, an XDR platform, or a SOAR platform may correlate trigger events with the specific bypass condition that produced the trigger.

The thresholds applied by the strong number match bypass 154, the high-cosine corroboration bypass 156, the multi-signal convergence bypass 158, and the weak convergence bypass 160 are configurable parameters. In one embodiment, the thresholds are loaded from a configuration store at startup of the system 10 and may be tuned through validation on a labeled evaluation corpus. The thresholds may be uniform across language tiers, as illustrated in FIG. 5, or may be tier-specific in alternative embodiments, in which case each language tier is associated with a distinct set of bypass thresholds.

A trigger verdict produced by the fast trigger path 162 or by the strong-signal bypass path 170, and a trigger verdict produced by the cross-encoder 38 on the gray zone path 166, are subject to the precision-support requirements enforced by the no-data guard module 36 of FIG. 1. The no-data guard module 36 operates in two modes. In a first mode, the no-data guard module 36 reroutes a fast trigger path 162 candidate from the fast trigger path 162 to the gray zone path 166 when the fused score 128 is below an upper bypass threshold, such as a threshold of approximately 0.85 in one embodiment, and no precision-support evidence is present. In a second mode, the no-data guard module 36 applies a hard cross-encoder floor, such as a floor of approximately 0.90 in one embodiment, to trigger decisions produced by the cross-encoder 38 when no precision-support evidence is present, in lieu of the tier-specific cross-encoder threshold. The no-data guard module 36 is described further in connection with a subsequent figure.

The confidence routing subsystem 150, by combining a coarse three-way partition based on the fused score 128 with a plurality of bypass conditions that capture distinct patterns of signal evidence and with the precision-support requirements enforced by the no-data guard module 36, achieves a combination of high precision, high recall, and low average latency that is difficult to achieve through threshold tuning of any single signal or through fixed invocation of a cross-encoder for every request. The fast trigger path 162 and the fast safe path 164 dispose of the substantial majority of input text 12 traffic without invocation of the cross-encoder 38, the strong-signal bypass path 170 captures multi-fact synthesis and colloquial-reformulation leaks that the cross-encoder 38 alone would miss, and the gray zone path 166 reserves the cross-encoder 38 for genuinely ambiguous input text 12 in which the joint-attention scoring of the cross-encoder 38 is most likely to add value.

### § 1.8 Cross-Encoder Reranking

Returning to FIG. 1, the cross-encoder 38 is implemented in one embodiment as a cross-encoder reranking subsystem that produces a cross-encoder score representing a joint-attention measure of relevance between the reference context 62 and the user input 64. The cross-encoder reranking subsystem is selectively invoked by the confidence routing subsystem 150 of FIG. 5 only for input text 12 routed onto the gray zone path 166, and produces the cross-encoder score in support of a trigger or allow decision 168 by the trigger or allow decision logic of the confidence routing subsystem 150.

The cross-encoder 38 differs in architectural character from the bi-encoder 24 of FIG. 1. The bi-encoder 24 encodes the reference context 62 and the user input 64 independently through separate forward passes of a transformer encoder, producing fixed-dimensional sentence embeddings that are compared via a dot product, as set forth in Equation (1). The cross-encoder 38, in contrast, encodes the reference context 62 and the user input 64 jointly through a single forward pass of a transformer encoder, in which the reference context 62 and the user input 64 are concatenated with a separator token and are presented together to the transformer encoder. The full self-attention mechanism of the transformer encoder permits each token of the reference context 62 to attend to each token of the user input 64, and vice versa, producing a joint representation that captures fine-grained interaction patterns between the two inputs. The joint representation is then reduced by a classification head to a scalar logit, which is normalized through a sigmoid function to produce the cross-encoder score in a range from approximately zero to approximately one.

The joint-attention architecture of the cross-encoder 38 captures interaction patterns that the bi-encoder 24 cannot capture, because the bi-encoder 24 encodes each input in isolation and cannot model token-level interactions between the reference context 62 and the user input 64. Cross-attention between specific tokens of the reference context 62 and specific tokens of the user input 64 enables the cross-encoder 38 to identify a paraphrase relationship in which the user input 64 reformulates content of the reference context 62 with substitute wording, to identify a partial reproduction relationship in which the user input 64 reproduces a fragment of the reference context 62, and to identify an inference relationship in which the user input 64 draws a conclusion that depends on specific facts of the reference context 62.

In one embodiment, the cross-encoder 38 is a multilingual transformer-based reranking model. In a particular embodiment, the cross-encoder 38 is based on a Multilingual Minimum Language Model (MiniLM) architecture distilled from a larger Cross-lingual Language Model RoBERTa (XLM-R) teacher model, having approximately twelve transformer layers, a hidden dimension of approximately three hundred eighty-four, and approximately thirty-three million parameters. The cross-encoder 38 is trained on a multilingual passage-ranking corpus, such as a multilingual variant of the Microsoft Machine Reading Comprehension (MS MARCO) corpus, covering a plurality of natural languages including English, Arabic, Chinese, Dutch, French, German, Hindi, Indonesian, Italian, Japanese, Portuguese, Russian, Spanish, and Vietnamese. The cross-encoder 38 may execute on a graphics processing unit (GPU), a tensor processing unit (TPU), a neural processing unit (NPU), or a general-purpose central processing unit (CPU), with automatic device selection and a fallback path from accelerator to CPU when no accelerator is available, and may operate under a reduced-precision arithmetic mode, such as a sixteen-bit floating-point (FP16) mixed-precision mode, an eight-bit integer (INT8) quantized mode, or a brain floating-point (BF16) mode.

The cross-encoder 38 imposes a higher computational cost per evaluation than the bi-encoder 24. The bi-encoder 24 produces independent embeddings of the reference context 62 and the user input 64 with computational cost on the order of O(n) plus O(m), in which n is the token length of the reference context 62 and m is the token length of the user input 64, and the embeddings produced by the bi-encoder 24 may be precomputed and reused across multiple evaluations. The cross-encoder 38, in contrast, produces a joint representation with computational cost on the order of O(n times m) due to the cross-attention between the reference context 62 and the user input 64, and the joint representation cannot be precomputed because it depends on both the reference context 62 and the user input 64 simultaneously. In one embodiment, a single invocation of the cross-encoder 38 incurs an inference latency on the order of approximately eight to twelve milliseconds per evaluation on a current-generation GPU.

The selective invocation of the cross-encoder 38 by the confidence routing subsystem 150 of FIG. 5 addresses the higher per-evaluation computational cost. The cross-encoder 38 is invoked only when the input text 12 is routed onto the gray zone path 166, which in experimental evaluation accounts for approximately twenty-seven percent of input text 12 traffic. The remaining approximately seventy-three percent of input text 12 traffic is disposed of via the fast trigger path 162, the fast safe path 164, or the strong-signal bypass path 170, each of which produces the trigger or allow decision 168 without invocation of the cross-encoder 38. The selective invocation reduces aggregate inference cost and aggregate end-to-end latency relative to a configuration in which the cross-encoder 38 is invoked for every input text 12.

The cross-encoder 38 receives the reference context 62 and the user input 64 in preprocessed canonical form from the request validator 16 of FIG. 1, with the same Unicode normalization, whitespace collapse, and null-byte removal applied to the bi-encoder 24, the entity NER extractor 26, the number match extractor 20, the text overlap extractor 28, and the code similarity extractor 30. The cross-encoder 38 applies its own tokenizer, which may be distinct from the tokenizer of the bi-encoder 24, to produce a joint token sequence consisting of a classification token, the tokens of the reference context 62, a separator token, and the tokens of the user input 64, with appropriate attention mask values for the joint token sequence. When the joint token sequence exceeds a maximum sequence length supported by the cross-encoder 38, the cross-encoder 38 may apply a chunking strategy analogous to the chunking strategy of the bi-encoder 24, in which a long reference context 62 is divided into a plurality of overlapping chunks and the cross-encoder 38 is invoked separately for each chunk paired with the user input 64. The cross-encoder 38 then combines the per-chunk cross-encoder scores into a single representative cross-encoder score, such as by selecting a maximum cross-encoder score across the plurality of chunks.

The cross-encoder score produced by the cross-encoder 38 is compared against a tier-specific cross-encoder threshold by the confidence routing subsystem 150 of FIG. 5 to produce the trigger or allow decision 168 on the gray zone path 166. The tier-specific cross-encoder threshold is selected based on the language code produced by the language detector 22 of FIG. 1, and takes a value such as approximately 0.60 for a first language tier, approximately 0.58 for a second language tier, and approximately 0.55 for a third language tier in one embodiment. When the cross-encoder score is greater than or equal to the tier-specific cross-encoder threshold, the trigger or allow decision 168 produces a trigger verdict, subject to the precision-support requirements enforced by the no-data guard module 36 of FIG. 1.

The cross-encoder 38 is subject to a hard cross-encoder floor enforced by the no-data guard module 36 of FIG. 1 in a second mode of operation, as introduced in connection with FIG. 5. When the cross-encoder 38 produces a cross-encoder score that exceeds the tier-specific cross-encoder threshold, but no precision-support evidence is present, the no-data guard module 36 substitutes a hard cross-encoder floor, such as a floor of approximately 0.90 in one embodiment, for the tier-specific cross-encoder threshold. The hard cross-encoder floor is substantially higher than each tier-specific cross-encoder threshold, so that a moderate cross-encoder score in the absence of precision-support evidence does not produce a trigger verdict. The hard cross-encoder floor addresses a class of edge case in which the cross-encoder 38 assigns a moderate relevance score to a user input 64 that is topically related to the reference context 62 but does not reproduce any specific entity, numerical pattern, code token, or content-bearing token combination from the reference context 62. The hard cross-encoder floor is described further in connection with the no-data guard module 36 in a subsequent section.

The cross-encoder 38 is loaded into memory once per replica of the system 10 and is shared across all invocations served by that replica. In one embodiment, the cross-encoder 38 is loaded eagerly at replica startup from a local artifact cache or, when the artifact is not present in the local cache, from a remote artifact store. The remote artifact store may be implemented as an object storage service, a model registry, or a distribution platform. The replica may apply an atomic write protocol when downloading the cross-encoder 38 from the remote artifact store, including a temporary write filename and a completion marker file written after the temporary write completes, so that a partially downloaded model artifact is not inadvertently loaded by a concurrent invocation. The replica may further apply a fallback strategy in which the cross-encoder 38 is loaded from a locally bundled package when the local artifact cache and the remote artifact store are both unavailable.

The cross-encoder 38 may be replaced with an alternative joint-attention model without departing from the scope of the disclosure. In alternative embodiments, the cross-encoder 38 is a Bidirectional Encoder Representations from Transformers (BERT) cross-encoder, a distilled BERT cross-encoder, a multilingual extension of either, or any other transformer-based model that produces a joint relevance score between a pair of input texts through full self-attention. The cross-encoder 38 may be trained on a passage-ranking corpus other than the multilingual MS MARCO corpus, on a natural language inference corpus, or on a custom semantic-leak detection corpus assembled from labeled examples of reference contexts and user inputs. The selection of a particular cross-encoder architecture and a particular training corpus affects the empirical accuracy and latency characteristics of the system 10 but does not alter the structural relationship between the cross-encoder 38, the weighted fusion module 32, the confidence routing subsystem 150, and the no-data guard module 36 disclosed herein.

The cross-encoder 38 complements the bi-encoder 24 by addressing semantic leak patterns that the bi-encoder 24 alone cannot resolve. A user input 64 in the gray zone, having a fused score 128 between the tier-specific low threshold and the tier-specific high threshold, exhibits moderate semantic similarity to the reference context 62 but does not produce sufficient signal evidence on the bi-encoder 24, the entity NER extractor 26, or the number match extractor 20 alone to produce a confident classification. The joint-attention scoring of the cross-encoder 38 resolves a substantial fraction of such gray-zone input text 12 by identifying fine-grained interaction patterns that the bi-encoder 24 cannot capture. The combination of selective invocation through the gray zone path 166, hard cross-encoder floor through the no-data guard module 36, and strong-signal bypass through the bypass condition evaluator 152 of FIG. 5 enables the cross-encoder 38 to contribute to detection accuracy without disproportionate impact on aggregate end-to-end latency.

### § 1.9 No-Data Guard

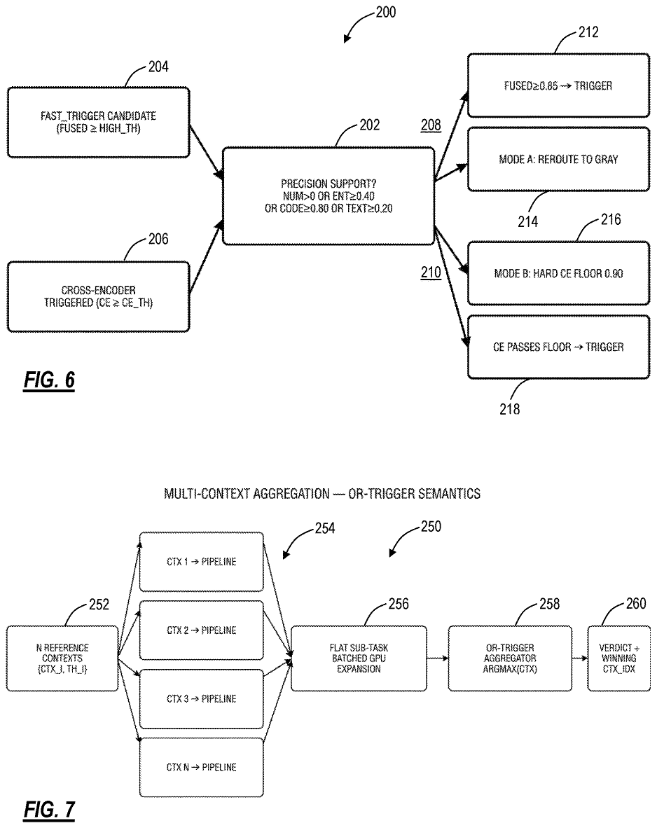

FIG. 6 is a diagram of a no-data guard subsystem 200 according to an embodiment of the present disclosure. The no-data guard subsystem 200 is an embodiment of the no-data guard module 36 of FIG. 1 and enforces precision-support requirements on trigger decisions produced by the confidence routing subsystem 150 of FIG. 5 and on trigger decisions produced by the cross-encoder 38 of FIG. 1. The no-data guard subsystem 200 includes a precision-support evaluator 202 that receives a fast trigger candidate 204 from the fast trigger path 162 of FIG. 5 and a cross-encoder trigger candidate 206 from the gray zone path 166 of FIG. 5 and that determines whether sufficient precision-support evidence is present to permit a trigger verdict. The no-data guard subsystem 200 operates in a first mode 208 and a second mode 210, and produces a fused-score trigger output 212, a reroute output 214, a cross-encoder trigger output 216, and a hard cross-encoder floor 218, depending on the operating mode and the result of the precision-support evaluation.

The precision-support evaluator 202 evaluates a precision-support condition based on a plurality of precision-support inputs. In one embodiment, the precision-support condition is a logical disjunction of four individual precision-support criteria, set forth in Equation (13):

precision_support=(C>0) OR (B≥0.40) OR (E≥0.80) OR (F≥0.20) (13)

in which C denotes the number match signal produced by the number match extractor 20 of FIG. 1, B denotes the entity overlap signal 82 produced by the entity NER extractor 26 of FIG. 1, E denotes the code similarity signal produced by the code similarity extractor 30 of FIG. 1, and F denotes the text token overlap signal produced by the text overlap extractor 28 of FIG. 1. The precision-support condition evaluates to true when any one of the four individual precision-support criteria is satisfied, and evaluates to false when none of the four individual precision-support criteria is satisfied. The individual thresholds applied within the precision-support condition, such as the approximately 0.40 threshold on the entity overlap signal 82, the approximately 0.80 threshold on the code similarity signal, and the approximately 0.20 threshold on the text token overlap signal, are configurable parameters in one embodiment.

The disjunctive structure of the precision-support condition reflects an architectural principle of the system 10. Each individual precision-support criterion is satisfied by a different class of high-precision evidence of reproduction. A satisfied number-match criterion indicates reproduction of one or more specific numerical patterns of the reference context 62 in the user input 64. A satisfied entity-overlap criterion indicates reproduction of a substantial fraction of named entities of the reference context 62 in the user input 64. A satisfied code-similarity criterion indicates reproduction of code tokens of the reference context 62 in the user input 64 in a context in which the user input 64 has been identified as containing code-like content. A satisfied text-token-overlap criterion indicates reproduction of a content-bearing token combination of the reference context 62 in the user input 64 in a context in which the user input 64 is not a request-style query. Any one of the four criteria, when satisfied, provides high-precision evidence of reproduction; collectively, the four criteria address the substantial majority of reproduction patterns encountered in enterprise LLM deployments.

The first mode 208 of the no-data guard subsystem 200 operates on the fast trigger candidate 204. The fast trigger candidate 204 is generated by the confidence routing subsystem 150 of FIG. 5 when the fused score 128 produced by the weighted fusion module 32 of FIG. 1 is greater than or equal to a tier-specific high threshold. The first mode 208 evaluates the fused score 128 against an upper bypass threshold and evaluates the precision-support condition against the plurality of precision-support inputs. The upper bypass threshold is greater than each tier-specific high threshold; in one embodiment, the upper bypass threshold is approximately 0.85.

The first mode 208 produces the fused-score trigger output 212 when the fused score 128 is greater than or equal to the upper bypass threshold. The fused-score trigger output 212 produces a trigger verdict regardless of whether the precision-support condition is satisfied, because a fused score 128 at or above the upper bypass threshold is sufficiently high to support a trigger verdict on the strength of the fused score 128 alone. The first mode 208 produces the fused-score trigger output 212 also when the fused score 128 is between the tier-specific high threshold and the upper bypass threshold and the precision-support condition is satisfied, so that a trigger verdict on the fast trigger path 162 is produced when precision-support evidence corroborates the fused score 128.

The first mode 208 produces the reroute output 214 when the fused score 128 is between the tier-specific high threshold and the upper bypass threshold and the precision-support condition is not satisfied. The reroute output 214 reroutes the fast trigger candidate 204 from the fast trigger path 162 to the gray zone path 166 of FIG. 5, so that the cross-encoder 38 of FIG. 1 is invoked to evaluate the joint relevance of the reference context 62 and the user input 64. The reroute output 214 prevents a precision-unsupported fast trigger candidate 204 from producing a trigger verdict without invocation of the cross-encoder 38, in cases in which the fused score 128 is high but is supported by cosine similarity alone in the absence of corroborating entity, number, code, or text token evidence.

The second mode 210 of the no-data guard subsystem 200 operates on the cross-encoder trigger candidate 206. The cross-encoder trigger candidate 206 is generated by the cross-encoder 38 of FIG. 1 when the cross-encoder 38 produces a cross-encoder score that is greater than or equal to a tier-specific cross-encoder threshold. The tier-specific cross-encoder threshold takes a value such as approximately 0.60 for a first language tier, approximately 0.58 for a second language tier, and approximately 0.55 for a third language tier in one embodiment. The second mode 210 evaluates the precision-support condition against the plurality of precision-support inputs and applies the hard cross-encoder floor 218 when the precision-support condition is not satisfied.

The second mode 210 produces the cross-encoder trigger output 216 when the cross-encoder score is greater than or equal to the tier-specific cross-encoder threshold and the precision-support condition is satisfied, in which case the trigger verdict is produced on the strength of the cross-encoder score corroborated by precision-support evidence. The second mode 210 also produces the cross-encoder trigger output 216 when the precision-support condition is not satisfied but the cross-encoder score is greater than or equal to the hard cross-encoder floor 218. In one embodiment, the hard cross-encoder floor 218 is approximately 0.90, which is substantially higher than each tier-specific cross-encoder threshold. The second mode 210 produces an allow verdict, rather than the cross-encoder trigger output 216, when the precision-support condition is not satisfied and the cross-encoder score is below the hard cross-encoder floor 218, even though the cross-encoder score may exceed the tier-specific cross-encoder threshold.

The hard cross-encoder floor 218 addresses a class of edge case in which the cross-encoder 38 produces a moderate cross-encoder score for a user input 64 that is topically related to the reference context 62 but does not reproduce any specific entity, numerical pattern, code token, or content-bearing token combination from the reference context 62. By way of illustration, a reference context 62 that recites that a particular quarterly net profit was a specific monetary amount and a particular margin was a specific percentage, paired with a user input 64 reciting that the same quarter's results were strong with healthy margins exceeding expectations, may produce a cross-encoder score in a moderate range, such as a score in the range of approximately 0.70 to approximately 0.89, that exceeds the tier-specific cross-encoder threshold but does not reflect reproduction of any specific fact from the reference context 62. Without the hard cross-encoder floor 218, the cross-encoder score in this range would produce a trigger verdict, which would be a false positive. With the hard cross-encoder floor 218 of approximately 0.90, the cross-encoder score in this range does not produce a trigger verdict in the absence of precision-support evidence, and the allow verdict is produced instead.

The two-mode design of the no-data guard subsystem 200 reflects an architectural principle that a trigger verdict requires either an unambiguously high score on a single signal, or a moderate score on a single signal corroborated by precision-support evidence drawn from an independent signal. The first mode 208 enforces this principle on the fast trigger path 162 by either permitting the trigger verdict when the fused score 128 is unambiguously high or requiring precision-support evidence when the fused score 128 is moderate. The second mode 210 enforces the same principle on the gray zone path 166 by either permitting the trigger verdict when the cross-encoder score is unambiguously high through the hard cross-encoder floor 218 or requiring precision-support evidence when the cross-encoder score is moderate.

The thresholds applied by the no-data guard subsystem 200 are configurable parameters. In one embodiment, the upper bypass threshold of approximately 0.85, the hard cross-encoder floor 218 of approximately 0.90, the entity overlap precision-support threshold of approximately 0.40, the code similarity precision-support threshold of approximately 0.80, and the text token overlap precision-support threshold of approximately 0.20 are loaded from a configuration store at startup of the system 10 and may be tuned through validation on a labeled evaluation corpus. The thresholds may be uniform across language tiers or may be tier-specific in alternative embodiments. In a tier-specific embodiment, each language tier is associated with a respective upper bypass threshold and a respective hard cross-encoder floor 218, such that the precision-support requirements vary with the expected reliability of the language-specific signal extractors of the system 10.

The precision-support condition of Equation (13) is not the only formulation contemplated by the present disclosure. In alternative embodiments, the precision-support evaluator 202 evaluates a weighted scoring formulation in which each precision-support input contributes a weighted contribution and the precision-support condition is satisfied when the sum of weighted contributions exceeds a precision-support sum threshold. In a further alternative embodiment, the precision-support evaluator 202 evaluates a learned classifier, such as a logistic regression, a gradient-boosted decision tree, or a small feed-forward neural network, that takes the precision-support inputs as features and produces a precision-support probability that is compared against a precision-support probability threshold. The disjunctive formulation of Equation (13) is preferred in the illustrated embodiment because it is inspectable, deterministic, and configurable without retraining.

The no-data guard subsystem 200, by enforcing precision-support requirements on both the fast trigger path 162 and the gray zone path 166, addresses a fundamental asymmetry in the cost of false positives and false negatives in enterprise data loss prevention. A false positive trigger verdict produced in the absence of precision-support evidence undermines user trust in the system 10, increases alert volume to security analysts, and may cause the system 10 to be partially disabled by operators experiencing alert fatigue. A false negative allow verdict, while undesirable, is mitigated by other layers of an enterprise security architecture, such as endpoint detection and response, identity access management, and post-hoc audit. The no-data guard subsystem 200 preferentially declines a marginal trigger candidate in the absence of corroborating precision-support evidence, in service of the system 10's overall precision and operator trust, while preserving recall through the strong-signal bypass path 170 of FIG. 5 and through the multi-signal convergence bypass 158 and the weak convergence bypass 160, which capture distributed-evidence and colloquial-reformulation leaks that the fused score 128 and the cross-encoder score alone would miss.

### § 1.10 Multi-Context Aggregation

FIG. 7 is a diagram of a multi-context aggregation subsystem 250 according to an embodiment of the present disclosure. The multi-context aggregation subsystem 250 is an embodiment of the multi-context aggregator 40 of FIG. 1 and supports evaluation of a user input 64 against a plurality of reference contexts 62 in a single detection request. The multi-context aggregation subsystem 250 includes a reference context set 252 containing the plurality of reference contexts and respective per-context thresholds, a per-context pipeline 254 instantiated for each reference context of the reference context set 252, a flat sub-task batched expansion module 256, an OR-trigger aggregator 258, and a verdict and winning context output 260.

The multi-context aggregation subsystem 250 addresses a deployment pattern in which an enterprise LLM-powered application supplies a plurality of reference documents to the LLM in a single prompt turn. By way of illustration, an enterprise LLM-powered application may supply, in a single prompt turn, a financial report drawn from a finance document store, a human resources data export drawn from a personnel system, a legal contract drawn from a contract management system, and a strategic planning document drawn from an executive document store. Each of the plurality of reference documents is treated by the enterprise as confidential, and a user input 64 that reproduces content from any one of the plurality of reference documents constitutes a semantic leak, regardless of which reference document was reproduced. The multi-context aggregation subsystem 250 evaluates the user input 64 against each reference document independently and produces a single aggregate verdict, together with an identification of which reference document was reproduced when a trigger verdict is produced.

The reference context set 252 includes the plurality of reference contexts 62 and a corresponding plurality of per-context thresholds. The reference context set 252 is represented in the figure as a set of tuples of the form (CTX_i, TH_i), in which CTX_i denotes the i-th reference context 62 in the reference context set 252 and TH_i denotes a per-context detection threshold associated with the i-th reference context 62. The cardinality of the reference context set 252 is denoted N and may take any positive integer value supported by the system 10. In one embodiment, the cardinality N is unbounded above by the system architecture and is bounded above only by a configurable maximum reference context count enforced by the request validator 16 of FIG. 1. In a particular embodiment, the configurable maximum reference context count may be set to a value such as approximately ten, approximately one hundred, or any other value selected based on capacity planning considerations.

The per-context detection threshold TH_i associated with the i-th reference context 62 controls the sensitivity of the per-context pipeline 254 for the i-th reference context 62, independently of the per-context detection thresholds associated with the other reference contexts of the reference context set 252. The per-context detection thresholds enable an enterprise to apply differential sensitivity across reference documents of different classification levels. By way of illustration, a reference context 62 containing customer personally identifiable information may be associated with a per-context detection threshold that is more sensitive than a per-context detection threshold associated with a reference context 62 containing publicly available marketing collateral, so that the multi-context aggregation subsystem 250 produces a trigger verdict more readily on reproduction of customer personally identifiable information than on reproduction of marketing collateral.

The per-context pipeline 254 represents the full processing pipeline of the system 10 instantiated for a single reference context 62 of the reference context set 252. Each per-context pipeline 254 includes the bi-encoder 24, the entity NER extractor 26, the number match extractor 20, the code similarity extractor 30, the text overlap extractor 28, the language detector 22, the weighted fusion module 32, the confidence routing subsystem 150 of FIG. 5, the cross-encoder 38, and the no-data guard subsystem 200 of FIG. 6, applied to the user input 64 paired with the i-th reference context 62. The per-context pipeline 254 produces a per-context verdict and a per-context confidence value for the i-th reference context 62, in which the per-context verdict indicates whether the user input 64 semantically reproduces content from the i-th reference context 62 and the per-context confidence value reflects the strength of the per-context verdict. In the embodiment of FIG. 7, the per-context pipelines 254 are illustrated as CTX 1→PIPELINE, CTX 2→PIPELINE, CTX 3→PIPELINE, through CTX N→PIPELINE, indicating that each reference context 62 of the reference context set 252 is associated with a respective instantiation of the per-context pipeline 254.

The flat sub-task batched expansion module 256 supports efficient processing of the plurality of per-context pipelines 254 across batched inference infrastructure. The flat sub-task batched expansion module 256 receives a batch of detection requests, in which each detection request includes a respective user input 64 and a respective reference context set 252, and expands the batch into a flat collection of (reference context, user input) pairs. The flat collection of pairs is then dispatched to the bi-encoder 24, the entity NER extractor 26, the number match extractor 20, the code similarity extractor 30, the text overlap extractor 28, and the cross-encoder 38 in a single batched forward pass or in a series of batched forward passes, depending on which signal extractor is invoked for which pair. The flat sub-task batched expansion module 256 maintains a mapping from each (reference context, user input) pair in the flat collection back to the originating detection request and to the index of the reference context 62 within the reference context set 252 of the originating detection request.

The flat sub-task batched expansion module 256 produces high accelerator utilization across heterogeneous batch compositions. By way of illustration, when an incoming batch of detection requests includes thirty-two single-context detection requests and four three-context detection requests, the flat sub-task batched expansion module 256 produces a flat collection of thirty-two plus twelve, or forty-four, (reference context, user input) pairs that are processed through the bi-encoder 24 in a single batched forward pass. The flat sub-task batched expansion module 256 thereby achieves accelerator utilization equivalent to processing forty-four single-context detection requests, rather than processing thirty-two single-context detection requests followed by separate three-pair batches for each of the four three-context detection requests. The flat expansion strategy is functionally equivalent to processing each (reference context, user input) pair through its own per-context pipeline 254 and does not alter the per-context verdict or the per-context confidence value produced for any pair.

The OR-trigger aggregator 258 receives the per-context verdict and the per-context confidence value produced by each per-context pipeline 254 and aggregates the per-context outputs into a single aggregate verdict. In one embodiment, the OR-trigger aggregator 258 applies an OR-trigger semantics, in which the aggregate verdict is a trigger verdict when the per-context verdict produced by any one of the per-context pipelines 254 is a trigger verdict, and the aggregate verdict is an allow verdict only when the per-context verdict produced by every one of the per-context pipelines 254 is an allow verdict. The OR-trigger semantics reflects an enterprise data loss prevention principle that reproduction of content from any reference document of the reference context set 252 constitutes a leak, irrespective of the verdicts on the other reference documents of the reference context set 252.

The OR-trigger aggregator 258 further produces a winning context index that identifies, when the aggregate verdict is a trigger verdict, which reference context 62 of the reference context set 252 was reproduced by the user input 64. When exactly one per-context pipeline 254 produces a trigger verdict, the winning context index is the index of the reference context 62 associated with that per-context pipeline 254. When more than one per-context pipeline 254 produces a trigger verdict, the OR-trigger aggregator 258 selects the winning context index based on a tie-breaking rule. In one embodiment, the tie-breaking rule selects the reference context 62 associated with the per-context pipeline 254 that produces the highest per-context confidence value, denoted argmax(CTX) in FIG. 7, so that the winning context index identifies the reference context 62 most strongly implicated by the user input 64. In alternative embodiments, the tie-breaking rule selects the reference context 62 having the lowest per-context detection threshold among the triggered per-context pipelines 254, the reference context 62 associated with the earliest index in the reference context set 252 among the triggered per-context pipelines 254, or a configurable preference order.

The verdict and winning context output 260 represents the output of the multi-context aggregation subsystem 250. The verdict and winning context output 260 includes the aggregate verdict and, when the aggregate verdict is a trigger verdict, the winning context index. The verdict and winning context output 260 corresponds to the leak or safe verdict 14 of FIG. 1, with the addition of the winning context index field for multi-context detection requests. The verdict and winning context output 260 may further include additional metadata for each per-context pipeline 254, such as the per-context verdict, the per-context confidence value, the decision path label produced by the confidence routing subsystem 150 of FIG. 5, and the signal scores produced by the bi-encoder 24, the entity NER extractor 26, the number match extractor 20, the code similarity extractor 30, the text overlap extractor 28, and the cross-encoder 38 for that per-context pipeline 254. The additional metadata enables downstream monitoring systems such as a SIEM, an XDR platform, or a SOAR platform to correlate the trigger verdict with the specific reference context 62 and the specific signal evidence that produced the trigger.

The multi-context aggregation subsystem 250 is backward compatible with single-context detection requests. When a detection request includes exactly one reference context 62 and one per-context detection threshold, the multi-context aggregation subsystem 250 instantiates a single per-context pipeline 254, and the OR-trigger aggregator 258 produces an aggregate verdict equal to the per-context verdict of that single per-context pipeline 254. In the single-context case, the winning context index may be omitted or may be set to a fixed value such as zero, depending on the embodiment. The backward compatibility enables the system 10 to expose a single detection application programming interface (API) that accepts both single-context and multi-context detection requests, without requiring a separate code path for single-context detection.

The OR-trigger semantics of the OR-trigger aggregator 258 is not the only aggregation formulation contemplated by the present disclosure. In alternative embodiments, the OR-trigger aggregator 258 implements an AND-trigger semantics, in which the aggregate verdict is a trigger verdict only when every one of the per-context pipelines 254 produces a trigger verdict; a weighted-vote semantics, in which each per-context pipeline 254 contributes a weighted vote based on the per-context confidence value and the aggregate verdict is a trigger verdict when the sum of weighted votes exceeds an aggregate threshold; or a configurable per-tenant semantics, in which the aggregation rule is selected by an enterprise tenant configuration setting. The OR-trigger semantics is preferred in the illustrated embodiment because it aligns with the enterprise data loss prevention principle that reproduction of any one reference document constitutes a leak, and because it is inspectable, deterministic, and configurable without retraining.

The multi-context aggregation subsystem 250 supports several enterprise deployment patterns that benefit from differential treatment of multiple reference documents. In one embodiment, the reference context set 252 is assembled from a retrieval augmented generation (RAG) pipeline that selects a plurality of relevant passages from an enterprise knowledge base in response to the user input 64, and the multi-context aggregation subsystem 250 evaluates the user input 64 against each retrieved passage independently. In another embodiment, the reference context set 252 is assembled from a plurality of departmental document stores in a multi-department deployment, with each reference context 62 corresponding to a respective department, so that the winning context index identifies the department whose reference document was reproduced. In a further embodiment, the reference context set 252 includes both an enterprise-supplied reference context 62 and a system prompt that defines the role and constraints of the LLM, so that the multi-context aggregation subsystem 250 detects reproduction of the system prompt as well as reproduction of the enterprise-supplied reference context 62.

The multi-context aggregation subsystem 250, by combining a plurality of per-context pipelines 254, a flat sub-task batched expansion module 256 that maintains high accelerator utilization across heterogeneous batches, an OR-trigger aggregator 258 that aligns with enterprise data loss prevention principles, and a verdict and winning context output 260 that supports downstream monitoring and analysis, extends the system 10 to enterprise deployment patterns in which multiple confidential reference documents are simultaneously supplied to the LLM. The per-context detection thresholds enable differential sensitivity across reference documents of different classification levels, and the winning context index enables a security analyst or a downstream monitoring system to identify the specific reference document that was reproduced by the user input 64 and to take appropriate remedial action.

### § 1.11 Fully Batched Inference Pipeline

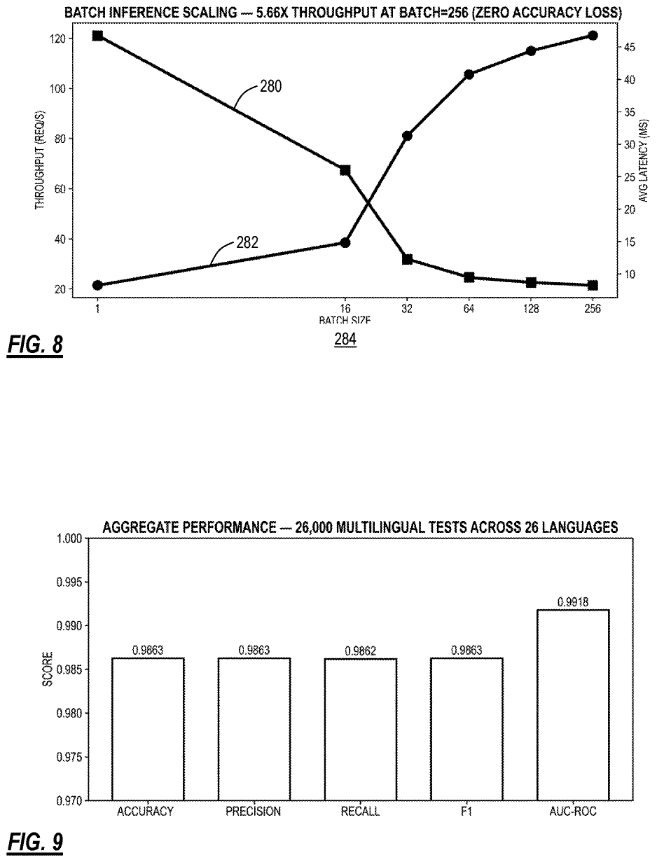

FIG. 8 is a graph illustrating batch inference scaling characteristics of the system 10 according to an embodiment of the present disclosure. The graph of FIG. 8 plots a throughput curve 280 and a latency curve 282 against a batch size axis 284 that ranges from a batch size of one through a batch size of approximately two hundred fifty-six. The throughput curve 280 is plotted against a throughput axis 286 expressed in detection requests per second and indicated on the left vertical edge of the graph. The latency curve 282 is plotted against a latency axis 288 expressed in average milliseconds per detection request and indicated on the right vertical edge of the graph.

The throughput curve 280 illustrates that aggregate throughput of the system 10 increases substantially as the batch size increases. At a batch size of one, corresponding to sequential single-request processing without batching, the system 10 produces a throughput of approximately twenty-one detection requests per second on a current-generation accelerator. At a batch size of approximately sixteen, throughput increases to approximately thirty-eight detection requests per second. At a batch size of approximately thirty-two, throughput increases to approximately eighty-one detection requests per second. At a batch size of approximately sixty-four, throughput increases to approximately one hundred six detection requests per second. At a batch size of approximately one hundred twenty-eight, throughput increases to approximately one hundred fifteen detection requests per second. At a batch size of approximately two hundred fifty-six, throughput approaches an asymptotic limit of approximately one hundred twenty-one detection requests per second.

The latency curve 282 illustrates that average per-request latency of the system 10 decreases substantially as the batch size increases, in inverse correspondence to the increase in throughput. At a batch size of one, the average per-request latency is approximately forty-seven milliseconds. At a batch size of approximately sixteen, the average per-request latency decreases to approximately twenty-six milliseconds. At a batch size of approximately thirty-two, the average per-request latency decreases to approximately twelve milliseconds. At a batch size of approximately sixty-four, the average per-request latency decreases to approximately nine milliseconds. At a batch size of approximately one hundred twenty-eight, the average per-request latency decreases to approximately nine milliseconds. At a batch size of approximately two hundred fifty-six, the average per-request latency approaches an asymptotic limit of approximately eight milliseconds.

The combination of the throughput curve 280 and the latency curve 282 illustrates that the system 10, when configured to operate in a fully batched inference mode, achieves approximately a five and one-half-fold to approximately a six-fold throughput improvement, and a corresponding decrease in average per-request latency, relative to sequential single-request processing. In one embodiment, the system 10 achieves approximately a five and sixty-six-hundredths-fold throughput improvement at a batch size of approximately two hundred fifty-six relative to sequential single-request processing at a batch size of one.

The fully batched inference pipeline includes a batched request validation component, a batched signal extraction component, a batched fusion and routing component, and a batched cross-encoder component. The batched request validation component receives a plurality of detection requests as a batch and applies the byte-level cap, the token-level cap, the threshold range check, and the preprocessing operations described in § 1.1 to each detection request in the batch in parallel. The batched request validation component separates the batch into a valid subset including detection requests that pass all validation checks and an invalid subset including detection requests that fail one or more validation checks. The invalid subset is returned with structured error responses without invoking any of the downstream batched components. The valid subset is forwarded to the batched signal extraction component.

The batched signal extraction component receives the valid subset of detection requests from the batched request validation component and executes each of the bi-encoder 24, the entity NER extractor 26, the number match extractor 20, the code similarity extractor 30, the text overlap extractor 28, and the language detector 22 of FIG. 1 in a batched fashion. The bi-encoder 24 produces sentence embeddings for the plurality of reference contexts 62 and the plurality of user inputs 64 in the valid subset by assembling an interleaved batch of paired token sequences and dispatching the interleaved batch to the transformer encoder 56 of FIG. 2 in a single forward pass, as described in § 1.1. The entity NER extractor 26 groups the plurality of detection requests in the valid subset by the language code produced by the language detector 22, dispatches each language-specific group through a corresponding spaCy NER model pipeline using a batched pipe interface, and produces a plurality of context entity sets and input entity sets across the valid subset in a single batched invocation per language group. The number match extractor 20, the code similarity extractor 30, and the text overlap extractor 28 process the plurality of detection requests in the valid subset through vectorized loops that apply the respective regular expressions, normalizers, tokenizers, and scorers to each detection request in turn, with intermediate results accumulated in batch-aligned data structures.

The batched fusion and routing component receives the plurality of signal scores produced by the batched signal extraction component for each detection request in the valid subset and applies the weighted fusion module 32 and the confidence routing subsystem 150 of FIG. 5 to each detection request in turn. The batched fusion and routing component separates the valid subset into a fast safe subset, a fast trigger subset, a strong-signal bypass subset, and a gray zone subset based on the fused score 128, the bypass condition evaluations, and the precision-support requirements. The batched fusion and routing component forwards the gray zone subset to the batched cross-encoder component for cross-encoder evaluation, and produces a verdict for each detection request in the fast safe subset, the fast trigger subset, and the strong-signal bypass subset without invocation of the cross-encoder 38.

The batched cross-encoder component receives the gray zone subset from the batched fusion and routing component and dispatches the plurality of (reference context, user input) pairs in the gray zone subset to the cross-encoder 38 in a single batched forward pass, or in a series of batched forward passes when the cardinality of the gray zone subset exceeds a configurable maximum cross-encoder batch size. The batched cross-encoder component produces a cross-encoder score for each detection request in the gray zone subset and forwards the cross-encoder scores to the no-data guard subsystem 200 of FIG. 6, which applies the precision-support requirements and the hard cross-encoder floor 218 to each detection request in turn to produce a final verdict.

The throughput and latency improvements illustrated in FIG. 8 derive from several sources. A first source is amortization of fixed per-invocation overhead, such as accelerator kernel launch overhead, memory allocation overhead, and Python interpreter overhead, across the plurality of detection requests in a batch. A second source is improved memory access locality on the accelerator, in which the plurality of token sequences in a batch are processed together with shared cache utilization. A third source is improved utilization of accelerator parallelism, in which the plurality of detection requests in a batch fill more of the available accelerator cores than a single detection request would. A fourth source is reduced overhead from cross-replica coordination in a clustered deployment of the system 10, in which a smaller number of larger batches require less coordination than a larger number of smaller batches.

The batched inference pipeline preserves the accuracy characteristics of the unbatched inference pipeline. Batching is a strictly mechanical optimization that affects how detection requests are scheduled onto the accelerator and how intermediate results are arranged in memory, but does not alter the signal scores produced by any of the signal extractors, the fused score produced by the weighted fusion module 32, the routing decisions produced by the confidence routing subsystem 150, the cross-encoder scores produced by the cross-encoder 38, or the precision-support determinations produced by the no-data guard subsystem 200. The decision path distribution across the fast safe path 164, the fast trigger path 162, the gray zone path 166, and the strong-signal bypass path 170 of FIG. 5 remains invariant across batch sizes, confirming that batching does not alter classification behavior.

The asymptotic behavior of the throughput curve 280 and the latency curve 282 in FIG. 8 reflects diminishing returns at large batch sizes. As the batch size increases, the marginal contribution of each additional detection request to throughput decreases, because the fixed per-invocation overhead is already amortized across a substantial number of detection requests at moderate batch sizes. At very large batch sizes, the throughput curve 280 approaches an asymptotic limit determined by the raw inference capacity of the accelerator, and the latency curve 282 approaches an asymptotic limit determined by the inference time required for a single detection request through the accelerator. In one embodiment, a production batch size in the range from approximately sixty-four to approximately one hundred twenty-eight is selected as a configuration that captures the substantial majority of available throughput improvement while bounding accelerator memory consumption per replica.

The batch size applied by the batched inference pipeline is a configurable parameter. In one embodiment, the batch size is selected based on available accelerator memory, on a target end-to-end latency, on a target throughput, on a queue depth observed at the replica entry point, or on a combination of the foregoing. The batched inference pipeline may further apply dynamic batching, in which the batched inference pipeline accumulates incoming detection requests in a queue until either a configurable batch size is reached or a configurable accumulation timeout expires, whichever occurs first, and then dispatches the accumulated batch through the batched request validation component. Dynamic batching balances throughput and latency by adapting the effective batch size to the incoming request rate without requiring static configuration.

The batched inference pipeline is not limited to the specific batch sizes illustrated in FIG. 8. The batch sizes of one, sixteen, thirty-two, sixty-four, one hundred twenty-eight, and two hundred fifty-six are exemplary points along the throughput curve 280 and the latency curve 282 and are recited for purposes of illustration. The batched inference pipeline may operate at any batch size in a range from one to a configurable maximum batch size, with the throughput and latency at intermediate batch sizes interpolating between the exemplary points illustrated in FIG. 8. The configurable maximum batch size may be selected based on accelerator memory capacity, on accelerator architecture, on inference framework constraints, or on other operational considerations.

The fully batched inference pipeline supports the multi-context aggregation subsystem 250 of FIG. 7 through the flat sub-task batched expansion module 256, which expands a multi-context detection request into a plurality of (reference context, user input) pairs that are processed alongside single-context detection requests in the same batched forward pass. The flat sub-task batched expansion module 256 maintains a mapping from each (reference context, user input) pair back to the originating detection request and to the index of the reference context 62 within the reference context set 252, so that the OR-trigger aggregator 258 of FIG. 7 may recover the per-context verdicts for each multi-context detection request after the batched inference pipeline produces the per-pair verdicts. The combination of the fully batched inference pipeline and the flat sub-task batched expansion module 256 enables the system 10 to support both single-context and multi-context detection requests at high throughput and low latency without requiring separate processing paths for the two request types.

### § 2.0 Evaluation Results

FIG. 9 is a bar chart illustrating aggregate performance characteristics of the system 10 across a multilingual evaluation corpus according to an embodiment of the present disclosure. The bar chart of FIG. 9 plots five evaluation metrics, including an accuracy metric, a precision metric, a recall metric, an F1 score metric, and an area under the receiver operating characteristic curve metric. Each evaluation metric is represented in the bar chart as a vertical bar with a height proportional to a measured value of the corresponding evaluation metric on a labeled evaluation corpus of approximately twenty-six thousand detection requests across approximately twenty-six natural languages.

The evaluation corpus represented in FIG. 9 includes approximately twenty-six thousand labeled detection requests, divided into approximately one thousand detection requests for each of approximately twenty-six natural languages. The detection requests for each natural language are balanced between approximately five hundred labeled leak detection requests, in which the user input 64 reproduces, paraphrases, summarizes, or otherwise semantically duplicates content from the reference context 62, and approximately five hundred labeled safe detection requests, in which the user input 64 is topically related to or unrelated to the reference context 62 but does not semantically reproduce content from the reference context 62. The labeled leak detection requests span a plurality of leak categories, including direct quotation, paraphrased disclosure, fact extraction, summarization, named entity exposure, competitive intelligence reproduction, legal clause reproduction, code and configuration reproduction, hybrid query-embedded reproduction, and numerical data reproduction. The labeled safe detection requests include topically related queries, unrelated queries, request-style queries, and other patterns of user input 64 that should not produce a trigger verdict.

The accuracy metric is computed as a fraction of detection requests in the evaluation corpus for which the verdict produced by the system 10 matches the corresponding label of the detection request. In the embodiment of FIG. 9, the system 10 achieves an accuracy metric of approximately 0.9863 across the evaluation corpus, indicating that approximately ninety-eight and six-tenths percent of detection requests in the evaluation corpus are classified correctly by the system 10.

The precision metric is computed as a fraction of detection requests for which the system 10 produces a trigger verdict that are also labeled as leak detection requests. The precision metric reflects the rate at which the system 10 produces a true positive trigger verdict among all trigger verdicts produced by the system 10. In the embodiment of FIG. 9, the system 10 achieves a precision metric of approximately 0.9863, indicating that approximately ninety-eight and six-tenths percent of trigger verdicts produced by the system 10 correspond to genuine leak detection requests.

The recall metric is computed as a fraction of labeled leak detection requests for which the system 10 produces a trigger verdict. The recall metric reflects the rate at which the system 10 detects a genuine leak among all genuine leaks in the evaluation corpus. In the embodiment of FIG. 9, the system 10 achieves a recall metric of approximately 0.9862, indicating that approximately ninety-eight and six-tenths percent of labeled leak detection requests are correctly identified by the system 10.

The F1 score metric is computed as a harmonic mean of the precision metric and the recall metric. The F1 score metric reflects a balanced measure of detection quality that penalizes both false positive trigger verdicts and false negative allow verdicts. In the embodiment of FIG. 9, the system 10 achieves an F1 score metric of approximately 0.9863.

The area under the receiver operating characteristic curve metric, denoted AUC-ROC, is computed as a numerical integration of a receiver operating characteristic curve. The receiver operating characteristic curve plots a true positive rate against a false positive rate as a decision threshold of the system 10 is varied across a range of values. The area under the receiver operating characteristic curve metric reflects an aggregate measure of detection quality across all decision thresholds, with a value of approximately 1.0 indicating perfect classification and a value of approximately 0.5 indicating chance-level classification. In the embodiment of FIG. 9, the system 10 achieves an area under the receiver operating characteristic curve metric of approximately 0.9918, indicating that the receiver operating characteristic curve of the system 10 is substantially close to the upper-left corner of the receiver operating characteristic plot.

The aggregate performance characteristics illustrated in FIG. 9 reflect detection quality of the system 10 across the substantial majority of natural languages encountered in enterprise LLM deployments. In one embodiment, the standard deviation of the F1 score metric across the approximately twenty-six natural languages of the evaluation corpus is on the order of a few thousandths, reflecting substantially uniform detection quality across natural languages. The substantially uniform detection quality is attributable to the tier-based adaptive weight redistribution scheme 120 of FIG. 4, which adjusts the fusion weights α, β, and γ based on the language tier of the input text 12 to compensate for variation in named entity recognition quality across natural languages, without requiring per-language retraining of any underlying machine learning model.

The aggregate performance characteristics illustrated in FIG. 9 may be compared against published performance characteristics of conventional approaches to data loss prevention. Traditional data loss prevention systems based on exact-match keywords, regular expressions, and document fingerprinting typically exhibit a false positive rate in a range of approximately one to approximately five percent, and a corresponding false negative rate that depends on the breadth of the keyword and regular expression coverage. Single-model approaches to semantic leak detection based on a sentence embedding bi-encoder, a cross-encoder, or a natural language inference classifier typically exhibit a false positive rate in a range of approximately two to approximately eight percent, and a false negative rate in a range of approximately ten to approximately twenty percent. The system 10, in the embodiment of FIG. 9, achieves a false positive rate of approximately one and four-tenths percent and a false negative rate of approximately one and four-tenths percent across approximately twenty-six natural languages, with mean end-to-end latency on the order of approximately twenty-five milliseconds per detection request and a ninety-fifth percentile end-to-end latency on the order of approximately twenty-seven milliseconds per detection request.

The aggregate performance characteristics illustrated in FIG. 9 reflect a particular embodiment of the system 10 evaluated on a particular evaluation corpus on particular hardware. The specific values of the accuracy metric, the precision metric, the recall metric, the F1 score metric, and the area under the receiver operating characteristic curve metric depend on the composition of the evaluation corpus, on the configuration of the system 10, and on the hardware on which the system 10 is executed. Alternative embodiments of the system 10, alternative evaluation corpora, and alternative hardware platforms may produce different specific values of the evaluation metrics. The relative ordering of the evaluation metrics, the substantially uniform per-language performance, and the substantial improvement over conventional data loss prevention and single-model semantic leak detection approaches are characteristic of the system 10 as a whole and are not limited to the specific embodiment evaluated in connection with FIG. 9.

The aggregate performance characteristics illustrated in FIG. 9 may be decomposed into contributions of individual components of the system 10 through an ablation analysis. In one embodiment, the ablation analysis evaluates the system 10 with one or more components disabled, such as a cosine-similarity-only configuration, an entity-overlap-only configuration, a number-match-only configuration, and various pairwise combinations of the cosine similarity score 52, the entity overlap signal 82, and the number match signal. The ablation analysis demonstrates that each signal extractor contributes a non-redundant detection capability, and that the bypass conditions of the confidence routing subsystem 150 of FIG. 5, the precision-support requirements of the no-data guard subsystem 200 of FIG. 6, and the tier-based adaptive weight redistribution scheme 120 of FIG. 4 each contribute incremental improvements to the aggregate performance characteristics of the system 10. The cosine similarity score 52 alone contributes a substantial baseline accuracy, and is augmented by the entity overlap signal 82 and the number match signal, which contribute high-precision precision-support evidence for trigger decisions. The bypass conditions contribute additional recall by capturing distributed-evidence and colloquial-reformulation leaks that the cosine similarity score 52 and the cross-encoder score alone would miss. The precision-support requirements and the hard cross-encoder floor 218 of FIG. 6 contribute additional precision by preventing precision-unsupported trigger candidates from producing trigger verdicts.

The aggregate performance characteristics illustrated in FIG. 9 are accompanied by per-language performance characteristics in one embodiment of the system 10. The per-language accuracy metric, precision metric, recall metric, F1 score metric, and area under the receiver operating characteristic curve metric each take values within a narrow range across the approximately twenty-six natural languages of the evaluation corpus. The per-language F1 score metric, by way of illustration, takes values in a range from approximately 0.981 for the natural language exhibiting the lowest per-language performance to approximately 0.990 for the natural language exhibiting the highest per-language performance, with a standard deviation across the approximately twenty-six natural languages on the order of approximately 0.003. The narrow range of per-language performance reflects the substantially uniform detection quality enabled by the tier-based adaptive weight redistribution scheme 120 of FIG. 4 and supports the deployment of the system 10 in enterprise environments serving users across a global natural language footprint.

The aggregate performance characteristics illustrated in FIG. 9 do not include performance on adversarial or out-of-distribution inputs. The system 10 may exhibit different performance characteristics on detection requests that are deliberately constructed to evade detection by the bi-encoder 24, the entity NER extractor 26, the number match extractor 20, the code similarity extractor 30, the text overlap extractor 28, or the cross-encoder 38, and on detection requests that are drawn from natural language distributions, content domains, or attack patterns not represented in the evaluation corpus. The system 10 may further be evaluated periodically against an updated evaluation corpus that incorporates emerging attack patterns and evolving natural language usage, and the fusion weights, routing thresholds, bypass thresholds, and precision-support thresholds of the system 10 may be retuned based on the updated evaluation corpus to maintain detection quality over time.

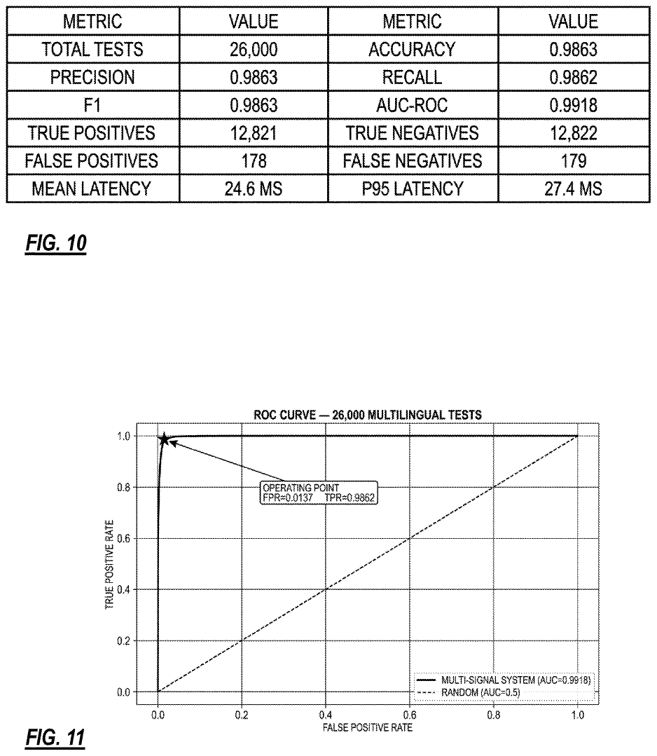

FIG. 10 is a table illustrating aggregate performance metrics of the system 10 across the multilingual evaluation corpus introduced in connection with FIG. 9, according to an embodiment of the present disclosure. The table of FIG. 10 includes a plurality of rows, each row associating a metric name with a corresponding metric value, and supplements the bar chart of FIG. 9 by presenting additional aggregate quantities derived from the same approximately twenty-six thousand detection request evaluation corpus.

The table of FIG. 10 includes a total tests row that recites a cardinality of the evaluation corpus of approximately twenty-six thousand detection requests. The table further includes an accuracy row that recites the accuracy metric of approximately 0.9863, a precision row that recites the precision metric of approximately 0.9863, a recall row that recites the recall metric of approximately 0.9862, an F1 score row that recites the F1 score metric of approximately 0.9863, and an area under the receiver operating characteristic curve row that recites the area under the receiver operating characteristic curve metric of approximately 0.9918. The accuracy metric, the precision metric, the recall metric, the F1 score metric, and the area under the receiver operating characteristic curve metric are computed in the manner described in connection with FIG. 9.

The table of FIG. 10 further includes a true positives row, a true negatives row, a false positives row, and a false negatives row. The true positives row recites a count of approximately twelve thousand eight hundred twenty-one detection requests for which the system 10 produces a trigger verdict and the corresponding label is a leak detection request. The true negatives row recites a count of approximately twelve thousand eight hundred twenty-two detection requests for which the system 10 produces an allow verdict and the corresponding label is a safe detection request. The false positives row recites a count of approximately one hundred seventy-eight detection requests for which the system 10 produces a trigger verdict but the corresponding label is a safe detection request, representing a false positive rate on the order of approximately one and four-tenths percent across the evaluation corpus. The false negatives row recites a count of approximately one hundred seventy-nine detection requests for which the system 10 produces an allow verdict but the corresponding label is a leak detection request, representing a false negative rate on the order of approximately one and four-tenths percent across the evaluation corpus.

The table of FIG. 10 further includes a mean latency row and a ninety-fifth percentile latency row. The mean latency row recites a mean end-to-end latency of approximately twenty-four and six-tenths milliseconds per detection request. The ninety-fifth percentile latency row recites a ninety-fifth percentile end-to-end latency of approximately twenty-seven and four-tenths milliseconds per detection request. The mean latency and the ninety-fifth percentile latency are measured across the approximately twenty-six thousand detection requests of the evaluation corpus and reflect the aggregate latency characteristics of the system 10 under the parallel signal extraction stage 18, the confidence routing subsystem 150 of FIG. 5, the selective invocation of the cross-encoder 38, and the no-data guard subsystem 200 of FIG. 6.

The mean end-to-end latency and the ninety-fifth percentile end-to-end latency illustrated in FIG. 10 are substantially below a thirty-millisecond service level agreement applicable to inline content inspection in enterprise LLM deployments. The latency characteristics derive from the selective invocation of the cross-encoder 38 by the confidence routing subsystem 150, in which approximately seventy-three percent of detection requests are disposed of without invocation of the cross-encoder 38, and from the parallel execution of the bi-encoder 24, the entity NER extractor 26, the number match extractor 20, the code similarity extractor 30, the text overlap extractor 28, and the language detector 22 in the parallel signal extraction stage 18 of FIG. 1.

The relationship between the confusion matrix entries and the recited metrics is set forth in Equation (14) through Equation (17). Accuracy is computed according to Equation (14):

accuracy=(TP+TN)/(TP+TN+FP+FN) (14)

in which TP denotes the count of true positives, TN denotes the count of true negatives, FP denotes the count of false positives, and FN denotes the count of false negatives. Precision is computed according to Equation (15):

precision=TP/(TP+FP) (15)

Recall is computed according to Equation (16):

recall=TP/(TP+FN) (16)

F1 score is computed according to Equation (17):

F1=(2×precision×recall)/(precision+recall) (17)

The specific values of the accuracy metric, the precision metric, the recall metric, and the F1 score metric recited in the table of FIG. 10 are derived from the true positive count, the true negative count, the false positive count, and the false negative count recited in the same table through the application of Equation (14), Equation (15), Equation (16), and Equation (17).

FIG. 11 is a graph illustrating a receiver operating characteristic curve of the system 10 across the multilingual evaluation corpus introduced in connection with FIG. 9, according to an embodiment of the present disclosure. The graph of FIG. 11 plots a true positive rate against a false positive rate as a decision threshold of the system 10 is varied across a range of values. The horizontal axis of the graph represents the false positive rate, computed as the count of false positive trigger verdicts divided by the total count of safe detection requests in the evaluation corpus. The vertical axis of the graph represents the true positive rate, computed as the count of true positive trigger verdicts divided by the total count of leak detection requests in the evaluation corpus. The true positive rate is equivalent to the recall metric described in connection with FIG. 9 and FIG. 10.

The receiver operating characteristic curve illustrated in FIG. 11 is generated by varying the decision threshold of the system 10 across a plurality of threshold values, and at each threshold value, computing the true positive rate and the false positive rate of the system 10 on the evaluation corpus. Each threshold value produces a respective operating point on the receiver operating characteristic curve. The plurality of operating points are connected to form the receiver operating characteristic curve, which traces the trade-off between true positive rate and false positive rate available to an operator of the system 10 through threshold tuning.

The receiver operating characteristic curve of FIG. 11 rises substantially vertically from an origin point at a false positive rate of approximately zero and a true positive rate of approximately zero to a point near an upper-left corner of the graph at a false positive rate of approximately zero and a true positive rate of approximately one, and then proceeds substantially horizontally to a point at a false positive rate of approximately one and a true positive rate of approximately one. The substantially vertical rise of the receiver operating characteristic curve indicates that the system 10 achieves a high true positive rate at a low false positive rate, which is a characteristic of high detection quality. The receiver operating characteristic curve of FIG. 11 is contrasted in the graph with a random classification baseline plotted as a diagonal line from the origin point to the upper-right corner of the graph. The random classification baseline represents a hypothetical classifier that produces a trigger verdict with a uniformly random probability and serves as a reference for the receiver operating characteristic curve of the system 10.

An operating point of the system 10 is indicated on the receiver operating characteristic curve of FIG. 11 at a false positive rate of approximately 0.0137 and a true positive rate of approximately 0.9862. The operating point corresponds to a particular decision threshold of the system 10 that produces the false positive rate of approximately one and four-tenths percent and the false negative rate of approximately one and four-tenths percent recited in FIG. 10. The operating point lies substantially close to the upper-left corner of the graph, reflecting the high detection quality of the system 10 at the recited operating threshold.

The area enclosed between the receiver operating characteristic curve of FIG. 11 and the horizontal axis of the graph is the area under the receiver operating characteristic curve metric, which takes a value of approximately 0.9918 in the embodiment of FIG. 11 and FIG. 9. The area under the receiver operating characteristic curve metric is computed by numerical integration across the plurality of operating points on the receiver operating characteristic curve. A receiver operating characteristic curve that traces the upper-left corner of the graph encloses an area of approximately 1.0 with the horizontal axis and corresponds to perfect classification, while the random classification baseline encloses an area of approximately 0.5 with the horizontal axis and corresponds to chance-level classification. The area under the receiver operating characteristic curve metric of approximately 0.9918 indicates that the receiver operating characteristic curve of the system 10 is substantially close to the perfect classification ideal.

The receiver operating characteristic curve of FIG. 11 illustrates the operating-threshold flexibility of the system 10. An operator of the system 10 may select an alternative operating threshold along the receiver operating characteristic curve to trade off true positive rate against false positive rate as appropriate for a particular enterprise deployment. By way of illustration, an enterprise deployment that prioritizes minimization of false positives may select a higher decision threshold that produces a lower false positive rate at the cost of a moderately reduced true positive rate, while an enterprise deployment that prioritizes maximization of true positives may select a lower decision threshold that produces a higher true positive rate at the cost of a moderately increased false positive rate. The substantially vertical character of the receiver operating characteristic curve near the upper-left corner indicates that the trade-off available through threshold tuning is favorable, in that substantial reductions in false positive rate are achievable with comparatively small reductions in true positive rate, and vice versa.

The receiver operating characteristic curve of FIG. 11 and the aggregate performance metrics of FIG. 9 and FIG. 10 collectively characterize the detection quality of the system 10 on the multilingual evaluation corpus. The graphs of FIG. 9, FIG. 10, and FIG. 11 should be understood together as a unified characterization, in which the bar chart of FIG. 9 presents the aggregate metric values, the table of FIG. 10 presents the underlying confusion matrix entries and latency characteristics from which the aggregate metric values are derived, and the receiver operating characteristic curve of FIG. 11 presents the threshold-dependent characterization of the operating point and the area under the receiver operating characteristic curve metric.

### § 2.1 Ablation Analysis

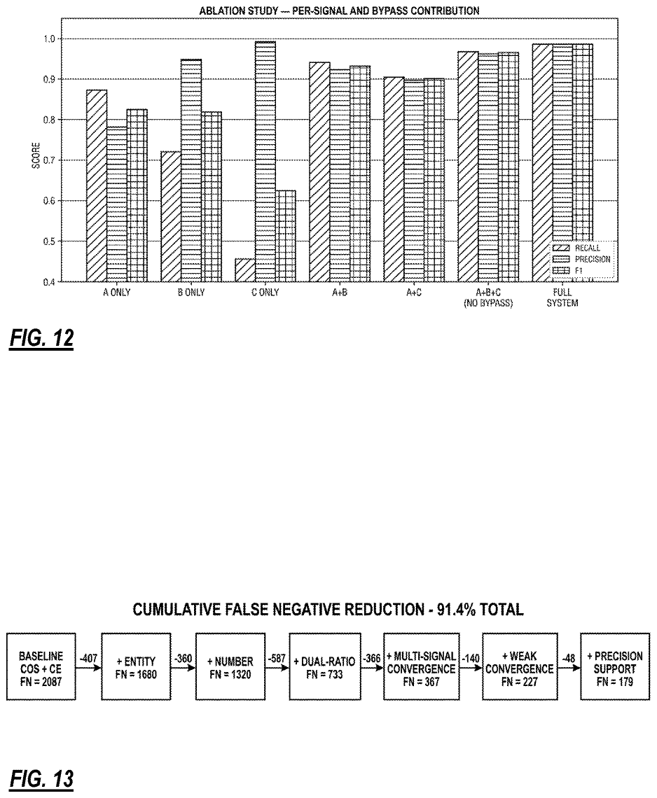

FIG. 12 is a bar chart illustrating an ablation analysis of the system 10 across a plurality of signal configurations according to an embodiment of the present disclosure. The ablation analysis includes a plurality of ablation configurations, in which each ablation configuration represents a variant of the system 10 with one or more signal extractors, bypass conditions, or precision-support mechanisms disabled. The bar chart of FIG. 12 plots a recall metric, a precision metric, and an F1 score metric for each ablation configuration, with the bars grouped by ablation configuration along a horizontal axis and the metric values plotted along a vertical axis. The ablation analysis demonstrates a non-redundant contribution of each signal extractor and a cumulative contribution of the bypass conditions and the precision-support mechanisms to the aggregate performance characteristics of the system 10.

The ablation analysis of FIG. 12 includes seven ablation configurations in one embodiment, ordered along the horizontal axis from a single-signal configuration to the full system 10 configuration. A first ablation configuration is a cosine-similarity-only configuration, denoted A only in FIG. 12, in which only the cosine similarity score 52 produced by the bi-encoder 24 of FIG. 1 is used as the basis for the trigger or allow decision 168. A second ablation configuration is an entity-overlap-only configuration, denoted B only, in which only the entity overlap signal 82 produced by the entity NER extractor 26 of FIG. 1 is used. A third ablation configuration is a number-match-only configuration, denoted C only, in which only the number match signal produced by the number match extractor 20 of FIG. 1 is used.

A fourth ablation configuration is a cosine-and-entity-overlap configuration, denoted A plus B, in which the cosine similarity score 52 and the entity overlap signal 82 are combined through the weighted fusion module 32 of FIG. 1 without the number match signal. A fifth ablation configuration is a cosine-and-number-match configuration, denoted A plus C, in which the cosine similarity score 52 and the number match signal are combined without the entity overlap signal 82. A sixth ablation configuration is a three-signal-no-bypass configuration, denoted A plus B plus C without bypass, in which the cosine similarity score 52, the entity overlap signal 82, and the number match signal are combined through the weighted fusion module 32 but the bypass condition evaluator 152 of FIG. 5 is disabled, so that the strong number match bypass 154, the high-cosine corroboration bypass 156, the multi-signal convergence bypass 158, and the weak convergence bypass 160 are not applied. A seventh ablation configuration is a full system configuration, denoted Full system, which includes all signal extractors, all bypass conditions, and all precision-support mechanisms of the system 10 as described in connection with FIG. 1 through FIG. 11.

The cosine-similarity-only configuration produces a recall metric of approximately 0.87, a precision metric of approximately 0.78, and an F1 score metric of approximately 0.83 in one embodiment. The cosine similarity score 52 alone captures a substantial fraction of leak detection requests through broad semantic similarity, but produces a comparatively elevated false positive rate because the cosine similarity score 52 alone does not distinguish between a genuine reproduction and a topically similar non-leaking query. The cosine-similarity-only configuration thereby establishes a baseline that the additional signal extractors and the additional architectural mechanisms of the system 10 each refine.

The entity-overlap-only configuration produces a recall metric of approximately 0.72, a precision metric of approximately 0.95, and an F1 score metric of approximately 0.82 in one embodiment. The entity overlap signal 82 alone exhibits substantially higher precision than the cosine similarity score 52 alone, reflecting that a named entity match between the reference context 62 and the user input 64 is a comparatively high-precision indicator of reproduction. The entity overlap signal 82 alone exhibits comparatively lower recall than the cosine similarity score 52 alone, because the entity overlap signal 82 evaluates to zero for leak detection requests that do not involve named entity reproduction.

The number-match-only configuration produces a recall metric of approximately 0.46, a precision metric of approximately 0.99, and an F1 score metric of approximately 0.63 in one embodiment. The number match signal alone exhibits the highest precision of any single-signal configuration, reflecting that a numerical pattern match between the reference context 62 and the user input 64 is rarely coincidental. The number match signal alone exhibits the lowest recall of any single-signal configuration, because the number match signal evaluates to zero for leak detection requests that do not involve numerical pattern reproduction, including a substantial fraction of paraphrased disclosure leaks, named entity exposure leaks, and content-only leaks.

The cosine-and-entity-overlap configuration produces a recall metric of approximately 0.94, a precision metric of approximately 0.93, and an F1 score metric of approximately 0.94 in one embodiment. The cosine-and-entity-overlap configuration captures both broad semantic similarity through the cosine similarity score 52 and named entity reproduction through the entity overlap signal 82, with the combined fused score 128 producing both higher recall and higher precision than either signal alone. The cosine-and-number-match configuration produces a recall metric of approximately 0.91, a precision metric of approximately 0.90, and an F1 score metric of approximately 0.90 in one embodiment. The cosine-and-number-match configuration captures both broad semantic similarity through the cosine similarity score 52 and numerical pattern reproduction through the number match signal, with comparable but slightly lower metric values than the cosine-and-entity-overlap configuration.

The three-signal-no-bypass configuration produces a recall metric of approximately 0.97, a precision metric of approximately 0.96, and an F1 score metric of approximately 0.97 in one embodiment. The three-signal-no-bypass configuration combines all three primary signals through the weighted fusion module 32 but does not apply the bypass condition evaluator 152 of FIG. 5. The three-signal-no-bypass configuration achieves substantially higher metric values than any pairwise combination, demonstrating that each of the cosine similarity score 52, the entity overlap signal 82, and the number match signal contributes non-redundant detection capability.

The full system configuration produces a recall metric of approximately 0.99, a precision metric of approximately 0.99, and an F1 score metric of approximately 0.99 in one embodiment, tracking the aggregate performance characteristics illustrated in FIG. 9 and FIG. 10. The full system configuration adds, on top of the three primary signals combined through the weighted fusion module 32, the bypass condition evaluator 152 of FIG. 5, the cross-encoder 38 of FIG. 1, the code similarity extractor 30, the text overlap extractor 28, and the no-data guard subsystem 200 of FIG. 6 with the hard cross-encoder floor 218. The bypass conditions and the precision-support mechanisms collectively reduce the false positive count and the false negative count relative to the three-signal-no-bypass configuration, demonstrating that the additional architectural mechanisms of the system 10 contribute incremental improvements over the baseline three-signal fusion.

The ablation analysis of FIG. 12 establishes several technical observations relevant to the architecture of the system 10. A first observation is that no single signal extractor of the system 10 is sufficient to achieve the aggregate performance characteristics of the full system 10. A second observation is that each pairwise combination of the cosine similarity score 52, the entity overlap signal 82, and the number match signal produces substantial improvement over the corresponding single-signal configuration, demonstrating non-redundant detection capability of each signal. A third observation is that the three-signal-no-bypass configuration does not capture the full performance of the system 10, and that the bypass conditions, the cross-encoder 38, the code similarity extractor 30, the text overlap extractor 28, and the no-data guard subsystem 200 each contribute incremental detection capability beyond the three-signal fusion. A fourth observation is that the bypass conditions and the precision-support mechanisms simultaneously increase recall and increase precision relative to the three-signal-no-bypass configuration, demonstrating that the architectural mechanisms of the system 10 are not subject to the conventional trade-off between recall and precision that constrains threshold-tuning-based approaches.

FIG. 13 is a bar chart illustrating a cumulative false negative reduction analysis of the system 10 across a plurality of architectural innovations according to an embodiment of the present disclosure. The cumulative false negative reduction analysis includes a plurality of cumulative configurations arranged along a horizontal axis, each cumulative configuration representing a successive addition of one architectural innovation to the previous cumulative configuration. A false negative count is plotted along a vertical axis for each cumulative configuration. The cumulative false negative reduction analysis demonstrates a marginal contribution of each architectural innovation to a reduction of the false negative count across the multilingual evaluation corpus introduced in connection with FIG. 9.

The cumulative false negative reduction analysis of FIG. 13 includes a plurality of cumulative configurations in one embodiment. A first cumulative configuration is a baseline configuration that includes only the bi-encoder 24 of FIG. 1 and the cross-encoder 38, denoted Baseline cos+CE in FIG. 13. The baseline configuration produces a false negative count of approximately two thousand eighty-seven across the approximately thirteen thousand leak detection requests in the evaluation corpus. A second cumulative configuration adds the entity overlap signal 82 produced by the entity NER extractor 26 to the baseline configuration, denoted Plus entity. The second cumulative configuration reduces the false negative count to approximately one thousand six hundred eighty.

A third cumulative configuration adds the number match signal produced by the number match extractor 20 to the second cumulative configuration, denoted Plus number. The third cumulative configuration reduces the false negative count to approximately one thousand three hundred twenty. A fourth cumulative configuration adds the dual-ratio scoring formulation with the minimum-match guard, as described in connection with FIG. 3 and § 1.3, to the third cumulative configuration, denoted Plus dual-ratio. The fourth cumulative configuration reduces the false negative count to approximately seven hundred thirty-three. The dual-ratio scoring formulation contributes a substantial reduction in the false negative count because the dual-ratio scoring formulation captures concentrated leaks in which a small number of named entities or numerical patterns are extracted from a large reference context 62, which a symmetric overlap formulation would substantially undercount.

A fifth cumulative configuration adds the multi-signal convergence bypass 158 of FIG. 5 to the fourth cumulative configuration, denoted Plus multi-signal convergence. The fifth cumulative configuration reduces the false negative count to approximately three hundred sixty-seven. The multi-signal convergence bypass 158 contributes a substantial reduction in the false negative count because the multi-signal convergence bypass 158 captures multi-fact synthesis leaks in which a user input 64 assembles entities, numerical patterns, and contextual meaning drawn from scattered sentences of the reference context 62, with no individual signal exceeding its individual trigger threshold but with simultaneous moderate-strength evidence across the three primary signals.

A sixth cumulative configuration adds the weak convergence bypass 160 of FIG. 5 to the fifth cumulative configuration, denoted Plus weak convergence. The sixth cumulative configuration reduces the false negative count to approximately two hundred twenty-seven. The weak convergence bypass 160 contributes a further reduction in the false negative count by capturing colloquially-reformulated leaks in which the cross-encoder 38 under-scores the joint relevance of the reference context 62 and the user input 64 due to slang, abbreviations, contractions, or informal phrasing in the user input 64.

A seventh cumulative configuration adds the precision-support signals produced by the code similarity extractor 30 and the text overlap extractor 28, together with the two-mode no-data guard subsystem 200 of FIG. 6, to the sixth cumulative configuration, denoted Plus precision support. The seventh cumulative configuration corresponds to the full system 10 configuration and reduces the false negative count to approximately one hundred seventy-nine, tracking the false negative count recited in connection with FIG. 10. The precision-support signals and the two-mode no-data guard subsystem 200 contribute a final reduction in the false negative count by enabling trigger decisions on leak detection requests that would otherwise be blocked by the precision-support requirements of the no-data guard subsystem 200, in cases in which the code similarity extractor 30 or the text overlap extractor 28 supplies precision-support evidence that the entity NER extractor 26 and the number match extractor 20 do not supply.

The cumulative false negative reduction analysis of FIG. 13 demonstrates that the system 10, in the full system configuration, reduces the false negative count from the approximately two thousand eighty-seven false negatives of the baseline configuration to the approximately one hundred seventy-nine false negatives of the full system configuration, representing a reduction in false negative count of approximately ninety-one and four-tenths percent relative to the baseline. The cumulative false negative reduction analysis further demonstrates that the reduction is achieved through a sequence of architectural innovations, each of which contributes a measurable marginal reduction in the false negative count, rather than through a single dominant mechanism. The dual-ratio scoring formulation, the multi-signal convergence bypass 158, and the combination of precision-support signals and the two-mode no-data guard subsystem 200 each contribute substantial marginal reductions, while the entity overlap signal 82 and the number match signal contribute moderate marginal reductions, and the weak convergence bypass 160 contributes a further marginal reduction.

The cumulative false negative reduction analysis of FIG. 13 complements the ablation analysis of FIG. 12. The ablation analysis of FIG. 12 measures the contribution of each signal extractor in isolation and in pairwise combination, while the cumulative false negative reduction analysis of FIG. 13 measures the contribution of each architectural innovation when added in a successive order to an accumulating system configuration. The two analyses together demonstrate that each component of the system 10 contributes non-redundant detection capability, both in isolation and in incremental addition to a baseline, and that the architecture of the system 10 cannot be reduced to a smaller subset of components without proportional degradation in detection quality.

### § 2.2 Decision Path Distribution

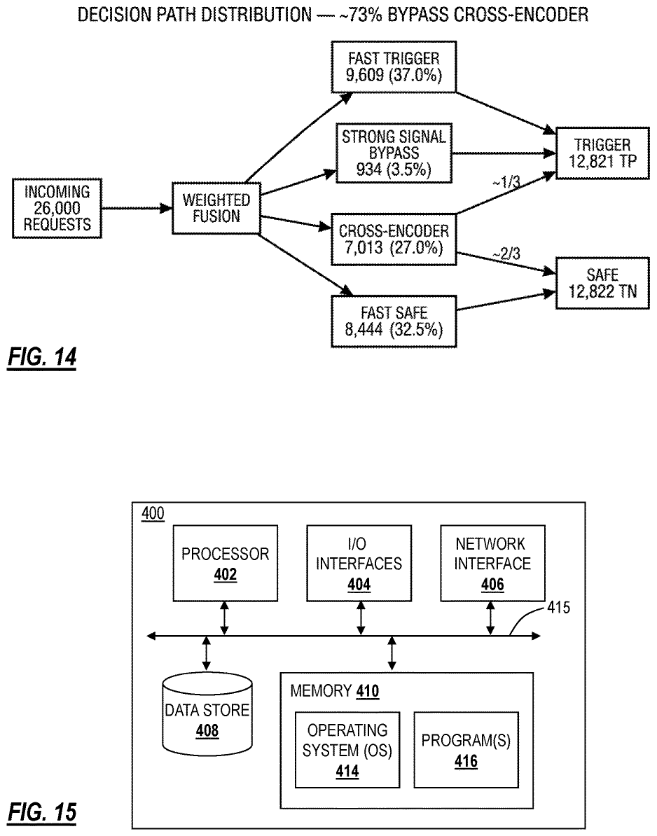

FIG. 14 is a diagram illustrating a decision path distribution of the system 10 across the multilingual evaluation corpus introduced in connection with FIG. 9, according to an embodiment of the present disclosure. The diagram of FIG. 14 represents traffic flow through the system 10 from the incoming detection requests, through the weighted fusion module 32 of FIG. 1 and the confidence routing subsystem 150 of FIG. 5, onto a plurality of decision paths, and to one of the leak or safe verdict 14 outputs. The diagram of FIG. 14 reports a respective fraction of the approximately twenty-six thousand detection requests in the evaluation corpus that traverse each decision path, demonstrating that the substantial majority of detection requests are disposed of without invocation of the cross-encoder 38 of FIG. 1.

The diagram of FIG. 14 includes an incoming requests entry point representing the approximately twenty-six thousand detection requests in the evaluation corpus, the weighted fusion module 32 of FIG. 1, four decision path branches, and two final verdict outputs corresponding to a trigger verdict and an allow verdict. The four decision path branches are the fast trigger path 162 of FIG. 5, the strong-signal bypass path 170 of FIG. 5, a cross-encoder path that traverses the gray zone path 166 of FIG. 5 and invokes the cross-encoder 38, and the fast safe path 164 of FIG. 5. Each decision path branch is labeled with a respective fraction of the approximately twenty-six thousand detection requests in the evaluation corpus that traverses the decision path branch.

The fast trigger path 162 of FIG. 5 receives approximately thirty-seven percent of the approximately twenty-six thousand detection requests in the evaluation corpus, or approximately nine thousand six hundred nine detection requests in one embodiment. The fast trigger path 162 is selected when the fused score 128 produced by the weighted fusion module 32 is greater than or equal to a tier-specific high threshold and the precision-support requirements of the no-data guard subsystem 200 of FIG. 6 are satisfied. Each detection request that traverses the fast trigger path 162 produces a trigger verdict at the trigger or allow decision 168 without invocation of the cross-encoder 38.

The strong-signal bypass path 170 of FIG. 5 receives approximately three and one-half percent of the approximately twenty-six thousand detection requests in the evaluation corpus, or approximately nine hundred thirty-four detection requests in one embodiment. The strong-signal bypass path 170 is selected when the bypass condition evaluator 152 of FIG. 5 determines that one or more of the strong number match bypass 154, the high-cosine corroboration bypass 156, the multi-signal convergence bypass 158, or the weak convergence bypass 160 is satisfied. Each detection request that traverses the strong-signal bypass path 170 produces a trigger verdict at the trigger or allow decision 168 without invocation of the cross-encoder 38, subject to the precision-support requirements of the no-data guard subsystem 200.

The cross-encoder path receives approximately twenty-seven percent of the approximately twenty-six thousand detection requests in the evaluation corpus, or approximately seven thousand thirteen detection requests in one embodiment. The cross-encoder path corresponds to the gray zone path 166 of FIG. 5 and is selected when the fused score 128 is between the tier-specific low threshold and the tier-specific high threshold and no bypass condition is satisfied. Each detection request that traverses the cross-encoder path invokes the cross-encoder 38 to produce a cross-encoder score, and the cross-encoder score is evaluated by the no-data guard subsystem 200 to produce a trigger verdict or an allow verdict at the trigger or allow decision 168. The cross-encoder path is the only decision path that incurs the per-invocation latency of the cross-encoder 38.

The fast safe path 164 of FIG. 5 receives approximately thirty-two and one-half percent of the approximately twenty-six thousand detection requests in the evaluation corpus, or approximately eight thousand four hundred forty-four detection requests in one embodiment. The fast safe path 164 is selected when the fused score 128 is less than or equal to a tier-specific low threshold. Each detection request that traverses the fast safe path 164 produces an allow verdict at the trigger or allow decision 168 without invocation of the cross-encoder 38.

The diagram of FIG. 14 further illustrates an aggregate outcome of the four decision path branches at the trigger or allow decision 168. The fast trigger path 162 and the strong-signal bypass path 170 contribute trigger verdicts directly. The cross-encoder path contributes a mixed outcome, with a subset of the cross-encoder path traffic producing trigger verdicts and a subset of the cross-encoder path traffic producing allow verdicts, depending on the cross-encoder score and the precision-support requirements. The fast safe path 164 contributes allow verdicts directly. In one embodiment, the cross-encoder path produces trigger verdicts and allow verdicts in an approximately one-to-two ratio, with approximately one-third of cross-encoder path traffic producing trigger verdicts and approximately two-thirds of cross-encoder path traffic producing allow verdicts. The aggregate outcome across all four decision path branches produces approximately twelve thousand eight hundred twenty-one trigger verdicts and approximately twelve thousand eight hundred twenty-two allow verdicts on the approximately twenty-six thousand detection request evaluation corpus, tracking the true positive count and the true negative count recited in connection with FIG. 10.

The decision path distribution illustrated in FIG. 14 demonstrates that approximately seventy-three percent of the approximately twenty-six thousand detection requests in the evaluation corpus are disposed of through the fast trigger path 162, the strong-signal bypass path 170, or the fast safe path 164 without invocation of the cross-encoder 38. The remaining approximately twenty-seven percent of detection requests traverse the cross-encoder path, in which the cross-encoder 38 is invoked to evaluate the joint relevance of the reference context 62 and the user input 64. The selective invocation of the cross-encoder 38 by the confidence routing subsystem 150 of FIG. 5 produces the mean end-to-end latency of approximately twenty-four and six-tenths milliseconds and the ninety-fifth percentile end-to-end latency of approximately twenty-seven and four-tenths milliseconds recited in connection with FIG. 10, both of which are substantially below a thirty-millisecond service level agreement applicable to inline content inspection.

The decision path distribution illustrated in FIG. 14 is a property of the evaluation corpus and the configuration of the system 10 recited in connection with FIG. 9 and FIG. 10. Alternative evaluation corpora, alternative configurations of the system 10, alternative threshold values, and alternative deployment contexts may produce different decision path distributions. By way of illustration, an enterprise deployment with a lower tier-specific high threshold and a higher tier-specific low threshold would expand the gray zone path 166 of FIG. 5 and reduce the fast trigger path 162 and the fast safe path 164, with a corresponding increase in cross-encoder path traffic and in mean end-to-end latency. An enterprise deployment with a higher tier-specific high threshold and a lower tier-specific low threshold would expand the fast safe path 164 and the fast trigger path 162 and reduce the gray zone path 166, with a corresponding decrease in cross-encoder path traffic and in mean end-to-end latency, at the cost of a potentially altered precision-recall trade-off.

The decision path distribution illustrated in FIG. 14 supports several technical observations relevant to the architecture of the system 10. A first observation is that the selective invocation of the cross-encoder 38 substantially reduces aggregate inference cost relative to a configuration in which the cross-encoder 38 is invoked for every detection request, while preserving the detection quality of joint-attention scoring for the gray-zone detection requests for which joint-attention scoring is most likely to add value. A second observation is that the strong-signal bypass path 170, despite carrying a comparatively small fraction of traffic, contributes disproportionately to recall by capturing multi-fact synthesis leaks and colloquially-reformulated leaks that the fused score 128 and the cross-encoder score alone would miss, as recited in connection with FIG. 13. A third observation is that the balance between the fast trigger path 162, the strong-signal bypass path 170, the cross-encoder path, and the fast safe path 164 is adjustable through threshold tuning, enabling an enterprise operator to trade off between aggregate latency, aggregate inference cost, and detection quality based on deployment requirements.

### § 3.0 Example Computing System Architecture

FIG. 15 is a block diagram of an example computing system 400 that may be used to implement one or more components described herein. The computing system 400 may take various forms, including, without limitation, a laptop, desktop, physical server, cluster of machines, virtual machine (VM) executing on a hypervisor, or a serverless computing framework. In general, the computing system 400 includes one or more processors 402, input/output (I/O) interfaces 404, a network interface 406, a data store 408, and memory 410. FIG. 15 provides a simplified representation; additional hardware and software elements may be present. The components 402-410 are coupled via a local interface 412, which may include one or more buses, high-speed interconnects, switching fabrics, or combinations thereof, and may further include controllers, buffers, caches, drivers, repeaters, receivers, and associated addressing and control lines.

The processor(s) 402 may include, for example, a central processing unit (CPU), multicore processor, system-on-chip (SoC), graphics processing unit (GPU), or a processing element within a distributed compute cluster. The processor(s) 402 may be general-purpose or specialized for performance, power efficiency, or workload-specific tasks. During operation, each processor 402 executes instructions stored in the memory 410, accesses data from the data store 408, and coordinates operation of the computing system 400. In large-scale deployments, multiple processors 402 may operate in parallel to process high volumes of traffic or complex workloads.

The I/O interfaces 404 provide communication between the computing system 400 and external peripherals, enabling user input (e.g., keyboard, touchscreen, sensors) and system output (e.g., displays, printers). In some implementations, the I/O interfaces 404 also support specialized devices for maintenance, debugging, or administrative tasks. The network interface 406 enables connectivity to external networks, including the Internet, private networks, or cloud environments, via technologies such as Ethernet, wireless LAN, cellular links, or virtualized network interfaces. The network interface 406 may support secure transport protocols and encryption to protect transmitted data, enabling safe participation in distributed or cloud-based architectures.

The data store 408 provides storage for both persistent and temporary data, and may include volatile memory (e.g., random access memory (RAM)) for high-speed operations and non-volatile media (e.g., solid-state drives, hard disk drives, optical storage) for long-term retention. In certain implementations, the data store 408 may be integrated with network-attached storage (NAS), storage area networks (SAN), or cloud-based storage systems. Features such as deduplication, compression, encryption-at-rest, and replication may be employed. Stored data may include operational logs, configuration data, policy definitions, executable binaries, and cached results.

The memory 410 serves as working memory for the processor(s) 402, and may include volatile components (e.g., dynamic RAM (DRAM), double data rate (DDR) memory, synchronous DRAM (SDRAM)) and/or non-volatile components (e.g., flash memory, non-volatile RAM (NVRAM)). In some implementations, the memory 410 is distributed across multiple nodes to support large-scale in-memory processing for cloud services. The memory 410 may store an operating system (O/S) 414, which manages processes such as scheduling, memory allocation, file management, and networking, as well as one or more programs 416 that implement functionality described herein.

The computing system 400 may be deployed in various cloud configurations, including a private cloud hosted within an organization's datacenter, a public cloud hosted by a third-party provider, or a hybrid cloud combining both. Cloud computing abstracts physical hardware into on-demand, scalable resources, enabling dynamic provisioning of compute, storage, and networking. The U.S. National Institute of Standards and Technology (NIST) defines cloud computing as “a model for enabling convenient, on-demand network access to a shared pool of configurable computing resources . . . that can be rapidly provisioned and released with minimal management effort or service provider interaction.” In Software-as-a-Service (SaaS) models, applications are typically delivered via web interfaces, eliminating the need for local installation and enabling centralized updates, security patches, and feature releases.

Various embodiments may use different forms of processing circuitry, including general-purpose microprocessors, digital signal processors (DSPs), network processors, GPUs, field-programmable gate arrays (FPGAs), programmable logic devices (PLDs), or application-specific integrated circuits (ASICs). Such circuitry may be controlled by software, firmware, or combinations thereof, and may be supplemented by non-processor circuits such as state machines. Implementations may also include a non-transitory computer-readable storage medium containing instructions that, when executed by processing circuitry, cause the computing system 400 to perform one or more methods described herein. Examples of such storage media include hard disks, optical media, magnetic media, ROM and its variants, flash memory, and other persistent or semi-persistent storage devices.

### § 4.0 Conclusion

In this disclosure, including the claims, the phrases “at least one of” and “one or more of,” when referring to a list of items, encompass any individual item as well as any combination of the listed items. For example, the expressions “at least one of A, B, or C,” “at least one of A, B, and C,” “one or more of A, B, or C,” and “one or more of A, B, and C” cover: only A; only B; only C; any combination of two of A, B, and C; or all three of A, B, and C. The terms “comprise,” “comprises,” “comprising,” “include,” “includes,” and “including” are intended to be open-ended and non-limiting, such that the recited elements, components, or steps do not exclude the presence or addition of one or more other elements, components, or steps.

The drawings, descriptions, and examples provided herein are for purposes of illustration and explanation and are not to be construed as limiting. Modifications, substitutions, additions, omissions, or rearrangements may be made without departing from the spirit and scope of the disclosure. Although certain steps, operations, instructions, blocks, or similar elements (collectively, “steps”) may be depicted or described in a particular order, such order is not required unless expressly stated, and does not imply that all steps are necessary. Steps may be performed before, after, concurrently with, or interleaved among other steps. Parallel execution, pipelining, multitasking, and other concurrent techniques are contemplated. Further, the partitioning of system components, modules, or functions described herein is illustrative; such components, modules, or functions may be combined, subdivided, replicated, or distributed across one or more devices or entities.

While the disclosure has been described with reference to particular embodiments and examples, those skilled in the art will appreciate that variations, modifications, and alternative implementations may provide equivalent functionality or comparable results. Such alternatives, whether or not expressly described, are within the scope of the disclosure if they are consistent with the principles described herein. Accordingly, the present disclosure encompasses combinations, permutations, and arrangements of the described elements, operations, methods, processes, algorithms, functions, techniques, modules, and circuits, whether implemented collectively, separately, or in subsets.

What is claimed is:

1. A method of detecting semantic leakage of contextual information in a prompt to a large language model (LLM), the method comprising:
extracting, in parallel from a reference context and a user input, a plurality of signals comprising a cosine similarity signal from multilingual sentence embeddings, an entity overlap signal from extracted named entities, and a number match signal from extracted numerical patterns;
selecting fusion weights from one of a plurality of language-tier weight profiles based on a detected language of the user input;
computing a fused score as a weighted combination of the plurality of signals using the selected fusion weights;
routing the reference context and the user input onto a fast trigger path, a fast safe path, or a gray zone path based on the fused score and one or more tier-specific thresholds;
selectively invoking a cross-encoder to produce a cross-encoder score only when the gray zone path is selected; and
producing a verdict indicating whether the user input semantically reproduces content from the reference context based on the fused score or the cross-encoder score.

2. The method of claim 1, wherein the entity overlap signal is a maximum of a context-anchored ratio and an input-anchored ratio, the context-anchored ratio being a matched entity count divided by a context entity count, the input-anchored ratio being the matched entity count divided by an input entity count.

3. The method of claim 2, wherein the input-anchored ratio is suppressed when the matched entity count is below a minimum-match threshold.

4. The method of claim 1, wherein the number match signal is computed by canonicalizing numerical patterns extracted from the reference context and the user input and applying a maximum of a context-anchored ratio and an input-anchored ratio subject to a minimum-match guard.

5. The method of claim 4, wherein canonicalizing the numerical patterns includes applying a last-separator heuristic across a plurality of international number formats including United States, European, and Indian lakh-and-crore formats.

6. The method of claim 4, wherein canonicalizing the numerical patterns includes converting a word-form numerical representation in at least one of the reference context and the user input into a canonical digit representation.

7. The method of claim 1, wherein the plurality of language-tier weight profiles includes a first profile for languages having dedicated named entity recognition (NER) models and a second profile for languages using a multilingual fallback NER model, a cosine weight increasing and an entity weight decreasing from the first profile to the second profile.

8. The method of claim 1, further comprising redistributing the selected fusion weights to remaining signals when at least one of the entity overlap signal and the number match signal is substantially zero.

9. The method of claim 1, further comprising producing a trigger verdict without invoking the cross-encoder when the number match signal exceeds an upper number bypass threshold and the cosine similarity signal exceeds a lower corroboration threshold.

10. The method of claim 1, further comprising producing a trigger verdict without invoking the cross-encoder when the cosine similarity signal exceeds an upper cosine bypass threshold and at least one of the entity overlap signal and the number match signal is non-zero.

11. The method of claim 1, further comprising producing a trigger verdict without invoking the cross-encoder when the cosine similarity signal, the entity overlap signal, and the number match signal simultaneously meet respective convergence thresholds.

12. The method of claim 1, further comprising producing a trigger verdict without invoking the cross-encoder when the cosine similarity signal, the entity overlap signal, the number match signal, and the fused score simultaneously meet respective weak convergence thresholds.

13. The method of claim 1, further comprising rerouting the reference context and the user input from the fast trigger path to the gray zone path when the fused score is below an upper bypass threshold and a precision-support condition is not satisfied.

14. The method of claim 13, further comprising comparing the cross-encoder score against a tier-specific cross-encoder threshold when the precision-support condition is satisfied and against a higher hard cross-encoder floor when the precision-support condition is not satisfied.

15. The method of claim 13, wherein the precision-support condition is satisfied when any of the number match signal is non-zero, the entity overlap signal meets an entity precision-support threshold, a code similarity signal meets a code precision-support threshold, or a text token overlap signal meets a text precision-support threshold.

16. The method of claim 15, further comprising computing the code similarity signal as a fraction of whitespace-normalized code tokens of the user input also present in the reference context, conditioned on a code gate that activates when the user input matches at least a minimum number of independent code indicators.

17. The method of claim 15, wherein the text token overlap signal is a product of a coverage component and a specificity component computed on content-bearing tokens after stopword removal from both sides and request-word removal from the user input.

18. The method of claim 1, wherein the reference context is one of a plurality of reference contexts each having a respective per-context detection threshold, and producing the verdict includes evaluating the user input against each reference context independently and aggregating per-context verdicts under OR-trigger semantics, the verdict identifying which reference context produced a trigger.

19. A system for detecting semantic leakage of contextual information in a prompt to a large language model (LLM), the system comprising:
one or more processors; and memory storing instructions that, when executed by the one or more processors, cause the system to:
extract, in parallel from a reference context and a user input, a plurality of signals comprising a cosine similarity signal from multilingual sentence embeddings, an entity overlap signal from extracted named entities, and a number match signal from extracted numerical patterns,
select fusion weights from one of a plurality of language-tier weight profiles based on a detected language of the user input,
compute a fused score as a weighted combination of the plurality of signals using the selected fusion weights,
route the reference context and the user input onto a fast trigger path, a fast safe path, or a gray zone path based on the fused score and one or more tier-specific thresholds,
selectively invoke a cross-encoder to produce a cross-encoder score only when the gray zone path is selected, and
produce a verdict indicating whether the user input semantically reproduces content from the reference context based on the fused score or the cross-encoder score.

20. A non-transitory computer-readable medium storing instructions that, when executed by one or more processors, cause the one or more processors to:
extract, in parallel from a reference context and a user input, a plurality of signals comprising a cosine similarity signal from multilingual sentence embeddings, an entity overlap signal from extracted named entities, and a number match signal from extracted numerical patterns,
select fusion weights from one of a plurality of language-tier weight profiles based on a detected language of the user input,
compute a fused score as a weighted combination of the plurality of signals using the selected fusion weights,
route the reference context and the user input onto a fast trigger path, a fast safe path, or a gray zone path based on the fused score and one or more tier-specific thresholds,
selectively invoke a cross-encoder to produce a cross-encoder score only when the gray zone path is selected, and
produce a verdict indicating whether the user input semantically reproduces content from the reference context based on the fused score or the cross-encoder score.
